(19) United States
(12) Patent Application Publication
(10) Pub. No.: US 2023/0363863 A1
(43) Pub. Date: Nov. 16, 2023

(54) SYSTEMS, METHODS AND DEVICES FOR PROVIDING CUSTOMIZED ORTHODONTICS DEVICES AND TECHNIQUES

(71) Applicant: SheepMedical Co. Ltd, Tokyo (JP)

(72) Inventors: Naozumi Matsumoto, Tokyo (JP); Lea A. Ellermeier, Dallas, TX (US)

(21) Appl. No.: 17/744,399

(22) Filed: May 13, 2022

(51) Int. Cl. A61C 7/10; A61C 9/00; A61C 7/00; B29C 64/188; B29C 64/393; B33Y 80/00

(52) U.S. Cl. CPC A61C 7/10; A61C 9/0046; A61C 7/002; B29C 64/188; B29C 64/393; B33Y 80/00; B33Y 10/00

(57) ABSTRACT

Various implementations of removable custom-shaped orthodontic aligners in combination with a removable custom-shaped orthodontic expander in the context of an orthodontic treatment of the patient, related systems, and computer program products and methods for the design and/or manufacturing of such aligners, and/or such expander are disclosed. In an exemplary implementation, multiple aligners of a series of staged aligners and the expander are configured to provide with each other a snap-in, form-lock interface so that the expander is positioned atop, positioned, and held by the aligner. An expander for the upper jaw may include an integrated bite plane. For example, computer program process steps planning the treatment and designing the aligners in combination with the expander are weighing interproximal reduction (IPR) versus transversal expansion. For example, method steps of manufacturing an expander employ numerical controlled machines for subtractive or additive manufacturing, such as 3D printers, to directly shape an expander.

### FIELD

This disclosure relates generally to techniques for providing orthodontic appliances for moving teeth in the context of an orthodontic treatment.

### BACKGROUND

Orthodontics is the practice of repositioning a patient's teeth to achieve better function and appearance. In general, low forces are induced to the teeth by a variety of orthodontic appliances causing the adjacent soft and hard tissue of the jaw to remodel and to thereby allow the teeth to move. Fix appliances utilize brackets that are adhesively bonded to a patient's teeth or held by metal bands around a patient's teeth and coupled together with a wire. The elastic deformation of the wire creates, in combination with the brackets, forces accomplishing the orthodontic movement of the teeth to such desired spatial position and orientation or inclination. Removable appliances work the same way but are dependent on the patient's compliance wearing them.

Removable orthodontic aligners, for example, are made from thermoplastic sheet material, typically pressure formed over a physical model of a patient's dentition that is waxed up based on a stone or gypsum model in a dental laboratory or 3D printed from a virtual individual model simulated in a computer. In either case a series of wax-ups or virtual models are mimicking the shapes of the patient's teeth repositioned to approach gradually, in sequencing stages, from a representation of the current improperly aligned (e.g., “maloccluded”) spatial position and orientation or inclination, to a representation of a desired spatial position and orientation or inclination of a patient's teeth of reasonable occlusion. The aligner then is cut out of the thermoformed sheet following a contour adjacent the gum line. Alternatively, the aligner can be directly 3D printed. Elastics, lever mechanics, head gears, bite planes or ramps and other auxiliary components are used to provide additional forces, sometimes directing mastication forces to complement the force field of the fixed or removable appliance. Forces between the teeth of each jaw move the individual teeth with respect to their spatial positions and orientations or inclinations against each other and/or reshape the overall arch form. Intermaxillary forces are provided to alter the spatial dimensional relationship between the teeth in the upper and lower jaw, for example, shifting the midline, correcting an overbite, and/or improving intercuspation with respect to the anterior-posterior, lateral and superior-inferior relationship of the lower jaw (mandible) and the upper jaw (maxilla), also together referred to as the occlusion of the bite. The occlusion of the bite also refers to the contact points between the teeth of the mandible and the maxilla in relation to the temporomandibular joints (TMJ) of the jaws and the dynamics of those contact points when the lower jaw moves in relation to the skull sideways, forwards, backwards, or at an angle, given the individual degrees of spatial freedom the occlusion and the TMJ provide.

Furthermore, an orthodontic expander is a removable device in the field of orthodontics which is used to widen the maxilla and/or the mandible so that the upper and the lower teeth will fit together. Although the use of an expander is most common in children and adolescents, it can also be used in adults. Typically, an orthodontic expander is used first and then followed by a removable or a fix orthodontic appliance system, as discussed above, to straighten the teeth. Expanders are made and custom-shaped based on orthodontic stone or gypsum models in a manual procedure in a dental laboratory. The core of the custom-shaped expander is a standard mass-produced expansion mechanic unit utilized and typically embedded in acrylic segments of the expander, or expander bodies that can be moved apart by means of the expansion mechanic unit. The patient is supposed to progressively turn a screw with right- and left-hand threads so that two respective threaded adapters of the unit are moved apart.

Additionally, if a patient presents a deep bite, a prescribed treatment plan may call for an intrusion of anterior teeth in the upper and/or the lower jaw of the patient. Typically a bite ramp or a bite plate is used to correct such deep bite. The bite ramp is positioned and placed so that the lower anterior teeth touch the surface the bite plane of such ramp or plate when closing the jaws. In this context mastication or closing forces are providing a force field that intrudes the front teeth.

Orthodontists and dentists that provide orthodontic care may have variant preferences with respect to their optimal occlusion strategy. The individual orthodontic treatment goals vary even more, and can use a wide variety of the devices discussed above. Often orthodontists must use multiple devices, increasing the complexity, costs, and time for providing orthodontic services, and with multiple potential areas for potential manufacturing errors, which poses a technical problem.

Typical orthodontal techniques have additional deficiencies, limitations, and technical problems. For instance, the devices described above lack efficiently removable orthodontic appliances that assist concurrently in the alignment of teeth and in orthodontic en masse movements expanding posterior teeth within a jaw of a patient. Further, these techniques lack efficient computer-based interactive software programs for planning an orthodontic treatment and designing/fabricating the orthodontic devices.

It is with these observations in mind, among others, that various aspects of the present disclosure were conceived and developed.

### SUMMARY

System, methods, and devices presented herein address the foregoing problems by providing one or more custom-shaped orthodontic devices. For instance, a system to assist in an orthodontic treatment of a patient can comprise: a plurality of orthodontic aligners configured to progressively reposition a plurality of teeth of a dental jaw of the patient during the orthodontic treatment when successively and operationally positioned; an orthodontic expander couplable to the plurality of orthodontic aligners and shaped to apply a transversal force that widens a dimensional distance between a plurality of right posterior teeth of the plurality of teeth and a plurality of left posterior teeth of the plurality of teeth of the dental jaw when positioned between the plurality of right posterior teeth and the plurality of left posterior teeth; wherein the orthodontic expander successively forms a plurality of right form-lock interfaces and a plurality of left form-lock interfaces with the successively positioned plurality of orthodontic aligners during the orthodontic treatment so that the plurality of orthodontic aligners position the orthodontic expander and act as an intermediary to translate the transversal force onto the plurality of right posterior teeth and onto the plurality of left posterior teeth.

In some instances, the plurality of orthodontic aligners have different right teeth-receiving cavity geometries adjacent the plurality of right posterior teeth, the right teeth-receiving cavity geometries selected to progressively reposition the plurality of right posterior teeth against each other during the orthodontic treatment when the plurality of orthodontic aligners are successively combined with the orthodontic expander; and the plurality of right form-lock interfaces have a same position relative to a plurality of right locking interfaces of the plurality of orthodontic aligners despite being positioned adjacent a lingual right posterior aligner shape variability of the different right teeth-receiving cavity geometries. In some examples, the plurality of orthodontic aligners have different left teeth-receiving cavity geometries adjacent the plurality of left posterior teeth, the left teeth-receiving cavity geometries selected to progressively reposition the plurality of left posterior teeth against each other during the orthodontic treatment when the plurality of orthodontic aligners are successively combined with the orthodontic expander; and wherein the plurality of left form-lock interfaces have a same position relative to a plurality of left locking interfaces of the plurality of orthodontic aligners despite being positioned adjacent a lingual left posterior aligner shape variability of the different left teeth-receiving cavity geometries.

In some scenarios, the orthodontic expander includes an aligner-facing right interface portion; the plurality of orthodontic aligners include a plurality of lingual right posterior aligner interface portions that, with the aligner facing right interface portion of the orthodontic expander, forms the plurality of right form-lock interfaces; the aligner-facing right interface portion includes an integral right mesial female connector portion and an integral right distal female connector portion; and the plurality of lingual right posterior aligner interface portions include: an integral right mesial male connector portion correlating to the right mesial female connector portion; and an integral right distal male connector portion correlating to the right distal female connector portion. Furthermore, in some instances, the orthodontic expander includes an aligner-facing left interface portion; the plurality of orthodontic aligners include a plurality of lingual left posterior aligner interface portions that, with the aligner-facing left interface portion, forms the plurality of left form-lock interfaces; the aligner-facing left interface portion includes an integral left mesial female connector portion and an integral left distal female connector portion; and the plurality of lingual left posterior aligner interface portions include: an integral left mesial male connector portion correlating to the left mesial female connector portion; and an integral left distal male connector portion correlating to the left distal female connector portion.

In some examples, a first right dimensional distance between a center of the right mesial male connector portion and a center of the right distal male connector portion is consistent and matches a second right dimensional distance between a center of the right mesial female connector portion and a center of the right distal female connector portion of the orthodontic expander while successively and operationally positioning the plurality of orthodontic aligners. Moreover, in some instances, a first left dimensional distance between a center of the left mesial male connector portion and a center of the left distal male connector portion is consistent and matches a second left dimensional distance between a center of the left mesial female connector portion and a center of the left distal female connector portion of the orthodontic expander while successively and operationally positioning the plurality of orthodontic aligners. In some scenarios, the dental jaw is an upper jaw, the plurality of orthodontic aligners are shaped as upper jaw aligners, and the orthodontic expander is shaped as an upper jaw expander comprising at least one extended portion having a bite plane surface configured to intrude a plurality of lower front teeth when operationally positioned. Furthermore, the dental jaw can be a lower jaw, the plurality of orthodontic aligners can be shaped as lower jaw aligners, and the orthodontic expander is shaped as a lower jaw expander. The system can also include an adjustable screw at the orthodontic expander to adjust the transversal force.

In some instances, a method of manufacturing a orthodontic expander to be concurrently used with a plurality of orthodontic aligners to assist in an orthodontic treatment of a patient comprises: determining an anatomical surface of a dental anatomy of a dental jaw of the patient; determining a widening dimensional distance between a plurality of right posterior teeth and a plurality of left posterior teeth of a plurality of teeth of a dental jaw of the patient to be formed with a transversal force applied by the orthodontic expander when the orthodontic expander is operationally positioned; forming a first surface of spatial extension of the orthodontic expander correlating to at least one spatially shaped surface of the anatomical surface; and forming a second surface of spatial extension of the orthodontic expander correlating to a virtual inverse surface of a corresponding at least one lingual posterior surface of spatial extension of at least one orthodontic aligner of the plurality of orthodontic aligners.

In some scenarios, the dental jaw is an upper jaw of the patient; the dental anatomy comprises a palate of the patient; and the orthodontic expander is shaped as an upper jaw expander, wherein the at least one surface of spatial extension faces the palate. In some examples, at least one custom-shaped surface of spatial extension of the orthodontic expander is a first custom-shaped surface of spatial extension of the orthodontic expander, and the method further comprises: forming a second custom-shaped surface of spatial extension of the orthodontic expander configured to intrude a plurality of lower front teeth when operationally positioned. In some instances, the dental jaw is a lower jaw of the patient; the dental anatomy is a lingual gingival mandibular anatomy of the patient; the orthodontic expander is shaped as a lower jaw expander; and the at least one surface of spatial extension faces the lingual gingival mandibular anatomy. Furthermore, by way of example, the at least one surface of spatial extension of the orthodontic expander includes a right spatially shaped surface and a left spatially shaped surface; the at least one lingual posterior surface includes a right lingual posterior surface and a left lingual posterior surface; the right spatially shaped surface and the right lingual posterior surface form a right form-lock interface; the left spatially shaped surface and the left lingual posterior surface form a left form-lock interface; and the right form-lock interface and the left form-lock interface position and hold the orthodontic expander when operationally combined. In some scenarios, forming the at least one surface of spatial extension of the orthodontic expander employs at least one of: a 3D printer configured to print at least a portion of the orthodontic expander from biocompatible material; a 5-axis computer numerical controlled (CNC) milling machine configured to machine at least a portion of the orthodontic expander from a biocompatible material blank; equipment using CNC based subtractive forming technologies; equipment using CNC based additive forming technologies; equipment using CNC based primary shaping or forming.

In some instances, the method further comprises: receiving a first physical model having a custom-shaped surface of spatial extension representative of the anatomical surface of the dental anatomy of the dental jaw of the patient; receiving a second physical model having at least one spatially shaped surface of spatial extension representative of the at least one lingual posterior surface of spatial extension of the orthodontic aligner; and wherein forming the first surface of spatial extension of the orthodontic expander uses the first physical model as a first tool, and forming the second surface of spatial extension uses the second physical model as a second tool. By way of example, the first physical model includes at least one of: a stone model, a gypsum model, a 3D printed model, or a wax-up model; and/or the second physical model includes at least one of: the at least one orthodontic aligner, a duplicate of the at least one orthodontic aligner, and a thermoformable sheet replicating at least a portion of the at least one orthodontic aligner. In some scenarios the method includes receiving a physical model having a custom-shaped surface of spatial extension correlating to the anatomical surface of the dental anatomy of the dental jaw of the patient; and wherein forming the at least one surface of spatial extension of the orthodontic expander uses the physical model as a mold.

In some examples, the method further comprises: receiving spatial imaging data descriptive of the dental anatomy of the dental jaw of the patient; receiving first numerical data descriptive of at least one lingual posterior surface of the orthodontic aligner; deriving a virtual custom-shaped model descriptive of at least the first surface of spatial extension and the second surface of the spatial extension from the spatial imaging data and the first numerical data; wherein forming the at first surface of spatial extension and the second surface of spatial extension uses computer numerical controlled (CNC) based equipment operating responsive to the virtual custom-shaped model.

In some instances, a method of manufacturing a plurality of orthodontic aligners configured to be concurrently used with an orthodontic expander to assist in an orthodontic treatment of a patient comprises: receiving a first virtual surface correlating to a first set of virtual crown geometries of a plurality of virtually repositioned teeth correlating to a plurality of teeth to thereby define a plurality of virtual teeth-receiving cavity geometries configured to reposition the plurality of teeth; receiving a second virtual surface correlating to a right lingual posterior interface and a left lingual posterior interface of the orthodontic aligner; wherein: a right lingual posterior interface of an orthodontic aligner of the plurality of orthodontic aligners is configured to form a right form-lock interface between the orthodontic expander and the orthodontic aligner; a left lingual posterior interface of the orthodontic aligner is configured to form a left form-lock interface between the orthodontic expander and the orthodontic aligner; and the orthodontic aligner uses the right form-lock interface and the left form-lock interface to position the orthodontic expander and act as an intermediary to translate a transversal force onto a plurality of right posterior teeth and a plurality of left posterior teeth, thus widening a dimensional distance between the plurality of right posterior teeth and the plurality of left posterior teeth of a dental jaw of the patient during the orthodontic treatment; and 3D printing a part at least partially responsive to the first virtual surface and the second virtual surface so that a first custom-shaped surface of spatial extension of the part correlates to the first virtual surface and a second surface of substantial spatial extension of the part correlates to the second virtual surface.

In some scenarios, the part is the orthodontic aligner of the plurality of orthodontic aligners; the part is a custom-shaped horseshoe, and/or the method further comprises thermoforming the orthodontic aligner using the custom-shaped horseshoe as a tool.

In some examples, computer program product to assist in an orthodontic treatment of a patient, the computer program product encodes a computer program for executing on a computer system a computer process, and the computer process comprising: receiving first numerical data including: a plurality of virtual jaw crown geometries; a plurality of virtual opponent jaw crown geometries; and a virtual maloccluded spatial arrangement of the plurality of virtual jaw crown geometries, and of the plurality of virtual opponent jaw crown geometries; wherein: the plurality of virtual jaw crown geometries represent a plurality of correlating crown anatomies of a plurality of jaw teeth of the patient; the plurality of virtual opponent jaw crown geometries represent a plurality of correlating crown anatomies of a plurality of opponent jaw teeth of the patient; and the virtual maloccluded spatial arrangement represents a maloccluded spatial arrangement of the plurality of jaw teeth and of the plurality of opponent jaw teeth including a crowded spatial arrangement of the plurality of jaw teeth; receiving second numerical data descriptive of at least one orthodontic space management criteria related to the plurality of jaw teeth, wherein the at least one orthodontic space management criteria includes a first prescription of an anticipated interproximal reduction (IPR) resolving the crowded spatial arrangement of the plurality of jaw teeth; reducing a plurality of virtual interproximal extensions of at least a portion of the plurality of virtual jaw crown geometries responsive to the first prescription to define a plurality of virtual updated crown geometries; simulating a virtual spatial arrangement of the plurality of virtual updated crown geometries having a transversally expanded virtual archform to resolve the crowded spatial arrangement; and displaying the virtual spatial arrangement of the plurality of virtual updated crown geometries having the transversally expanded virtual archform.

Furthermore, in some instances, the computer system comprises one or more processors that receive the computer program from a non-transitory processor-readable memory, and displaying the virtual spatial arrangement of the plurality of virtual updated crown geometries includes presenting the virtual spatial arrangement at a user interface of a clinic device.

In some scenarios, a computer implemented method to assist in an orthodontic treatment of a patient presenting anterior crowding in a dental jaw comprises: receiving a plurality of virtual crown geometries descriptive of a plurality of teeth of the dental jaw of the patient; providing a user interface in a first area of a computer screen to receive a prescription of an anticipated interproximal reduction of a tooth or a plurality of teeth; simulating an orthodontic treatment of the patient virtually resolving the anterior crowding responsive to a user input at the user interface, to thereby define a prescription; and displaying a virtual orthodontic model, resulting from simulating the orthodontic treatment, on a second area of the computer screen at least in an occlusal view of the virtual orthodontic model; wherein simulating the orthodontic treatment includes: modifying the plurality of virtual crown geometries responsive to the prescription; applying a virtual transversal expansion to widen a distance between right and left posterior crowns of the plurality of virtual crown geometries; and aligning anterior crowns of the plurality of virtual crown geometries so that the anterior crowding is resolved.

In some scenarios, the prescription omits anticipated interproximal reduction of a tooth or a plurality of teeth, and the anterior crowding is resolved fully by the virtual transversal expansion to widen a distance between right and left posterior crowns.

Additional aspects, advantages, and/or utilities of the presently disclosed technology are set forth in part in the description that follows and, in part, will be apparent from the description, or may be learned by practice of the presently disclosed technology.

### BRIEF DESCRIPTION OF THE DRAWINGS

So that the manner in which the features, advantages, and objects of the technology, as well as others which will become apparent, are attained, and can be understood in more detail, more particular description of the technology briefly summarized above may be had by reference to the embodiments thereof which are illustrated in the appended drawings that form a part of this specification. It is to be noted, however, that the drawings illustrate only certain embodiments of the disclosed technology and are therefore not to be considered limiting of its scope as the disclosed technology may admit to other equally effective embodiments.

FIG. 1 shows several occlusal view illustrations of an exemplary embodiment of a system to assist in an orthodontic treatment of a patient comprising an orthodontic aligner and an orthodontic expander in accordance with one or more embodiments of the presently disclosed technology.

FIG. 2 shows several views of an exemplary embodiment of an operational placement of an orthodontic aligner in accordance with one or more embodiments of the presently disclosed technology.

FIG. 3 shows several lateral cross-sectional view illustrations of an exemplary embodiment of a system to assist in an orthodontic treatment of a patient comprising an orthodontic aligner and an orthodontic expander in accordance with one or more embodiments of the presently disclosed technology.

FIG. 4 shows a lateral cross-sectional view illustration of an exemplary embodiment of a system to assist in an orthodontic treatment of a patient comprising an orthodontic aligner, an orthodontic expander, and a bite plane in accordance with one or more embodiments of the presently disclosed technology.

FIG. 5 shows several frontal cross-sectional view illustrations of an exemplary embodiment of a system to assist in an orthodontic treatment of a patient comprising an orthodontic aligner and an orthodontic expander in accordance with one or more embodiments of the presently disclosed technology.

FIG. 6 shows a frontal cross-sectional view illustration of an exemplary embodiment of an augmented or otherwise modified 3D printed jaw model utilized as a tool in a process to manufacture an orthodontic aligner in accordance with one or more embodiments of the presently disclosed technology.

FIG. 7 shows a frontal cross-sectional view illustration of an exemplary embodiment of an augmented or otherwise modified 3D printed jaw model utilized as a mold in a process to manufacture an orthodontic expander in accordance with one or more embodiments of the presently disclosed technology.

FIG. 8 shows a detailed cross-sectional occlusal view illustration of an exemplary embodiment of a form-lock interface between an orthodontic aligner and an orthodontic expander in accordance with one or more embodiments of the presently disclosed technology.

FIG. 9 shows several occlusal view illustrations of an exemplary embodiment of multiple method steps and various software functions and display options of arrangements of a plurality of teeth in the context of orthodontic space management in accordance with one or more embodiments of the presently disclosed technology.

FIG. 10 shows a block diagram of exemplary embodiment of an orthodontic treatment and related information technology (IT) and other systems configuration and method steps in accordance with one or more embodiments of the presently disclosed technology.

FIG. 11 shows an exemplary embodiment of a space management display of a user interface (UI) generated by a treatment planning computer program product method in accordance with one or more embodiments of the presently disclosed technology.

FIG. 12 shows a flow diagram for a plurality of method steps for designing and manufacturing an orthodontic aligner and/or an orthodontic expander in accordance with one or more embodiments of the presently disclosed technology.

FIG. 13 shows a flow diagram for a plurality of method steps for designing and manufacturing an orthodontic aligner and/or an engager bonding template in accordance with one or more embodiments of the presently disclosed technology.

FIG. 14 shows a flow diagram for a plurality of method steps for designing and manufacturing an orthodontic aligner and/or an orthodontic expander in accordance with one or more embodiments of the presently disclosed technology.

FIG. 15 shows a flow diagram for a plurality of method steps for designing and manufacturing an orthodontic expander in accordance with one or more embodiments of the presently disclosed technology.

FIG. 16 shows a flow diagram for a plurality of method steps for designing and manufacturing an orthodontic expander in accordance with one or more embodiments of the presently disclosed technology.

FIG. 17 shows a flow diagram for a plurality of method steps for designing and manufacturing an orthodontic expander in accordance with one or more embodiments of the presently disclosed technology.

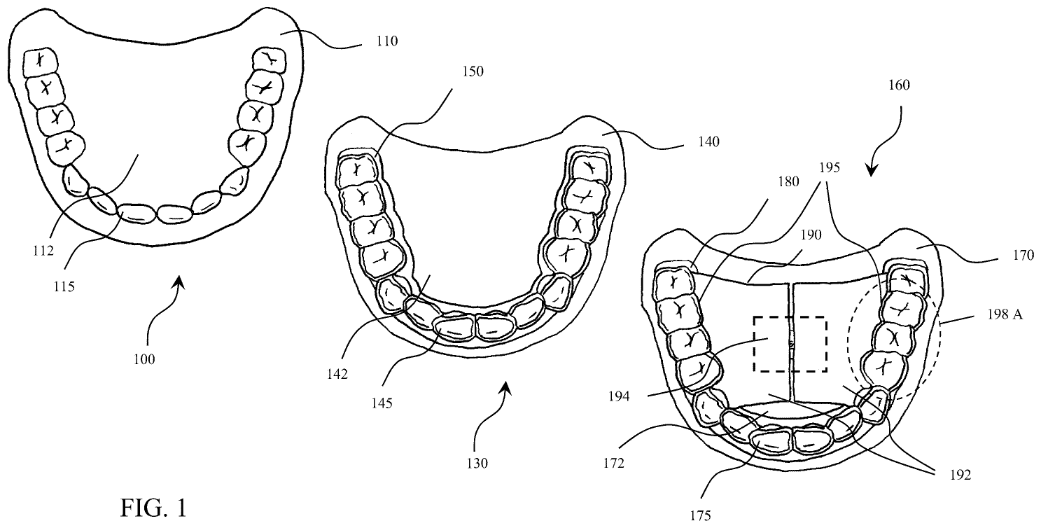

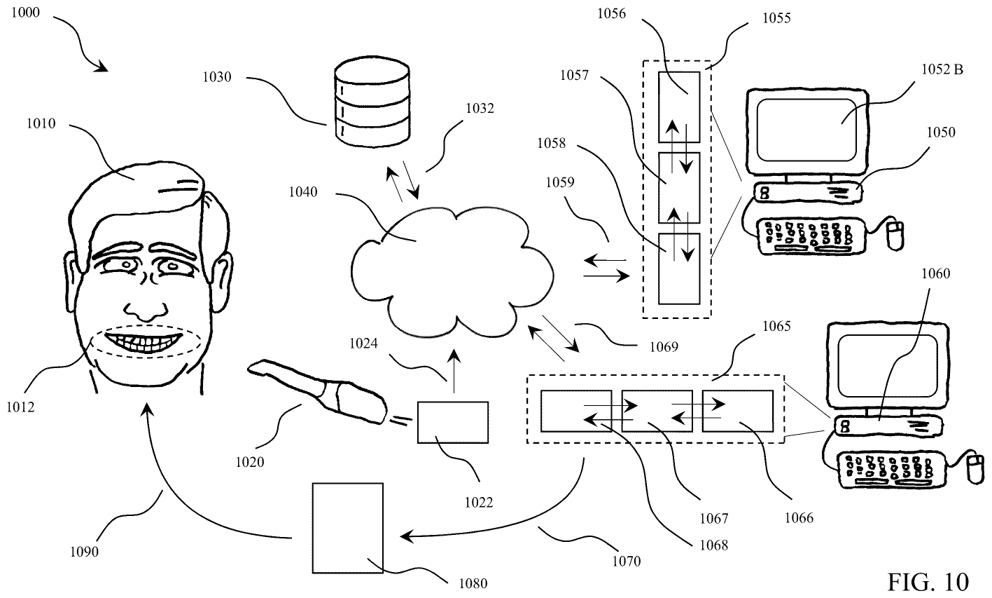

It should be noted that the first digit of a three-number numeral representing an element in the drawings refers to the number of the respective figures FIG. 1 to FIG. 9. It should be noted that the first two digits of a four-number numeral representing an element in the drawings refer to the number of the respective figures FIG. 10 to FIG. 17.

### DETAILED DESCRIPTION

The presently disclosed technology will now be described more fully hereinafter with reference to the accompanying drawings, which illustrate embodiments of the presently disclosed techniques. This technology may, however, be embodied in many different forms and should not be construed as limited to the illustrated embodiments set forth herein. Rather, these embodiments are provided so that this disclosure will be thorough and complete, and will fully convey the scope of the presently disclosed technology to those skilled in the art. Like numbers refer to like elements throughout. The different numbering of identical or similar components and/or prime notation, if used, indicates similar elements in alternative embodiments and/or configurations.

Throughout this specification the term “orthodontics” and derivative or similar words shall be understood as being generic to all possible meanings supported by the specification and by the words itself; the meaning shall, however, include herein, without limiting the foregoing and unless the context requires otherwise, a specialty of dentistry that addresses the diagnosis, prevention, and correction of mal-positioned teeth and jaws, and misaligned bite patterns.

Throughout this specification the term “orthodontic model” and derivative or similar words shall be understood as being generic to all possible meanings supported by the specification and by the words itself; the meaning shall, however, include herein, without limiting the foregoing and unless the context requires otherwise, a three-dimensional physical orthodontic model or a two-dimensional, three-dimensional or a four-dimensional virtual orthodontic model representing a past, present, future, or projected state of a dental anatomy. Further, throughout this specification the term “orthodontic model” shall be understand synonym to the term “dental model” and vice versa.

The term “three-dimensional” shall be understood herein as something of two-dimensional extension and the changes thereof throughout time, or as something of three-dimensional, spatial extension, as the context suggests. The term “four-dimensional” shall be understood herein as something of three-dimensional, spatial extension and the changes thereof throughout time.

Throughout this specification the term “image data” and derivative or similar words shall be understood as being generic to all possible meanings supported by the specification and by the words itself; the meaning shall, however, include herein, without limiting the foregoing and unless the context requires otherwise, any numerical or computer-implemented two-dimensional, three-dimensional, or four-dimensional description, representation, reproduction, or imitation of the appearance of a person or a thing, or parts thereof.

Throughout this specification the term “model” without any specifier shall be understood herein as a “virtual model”. Throughout this specification the term “virtual model” and derivative or similar words shall be understood as being generic to all possible meanings supported by the specification and by the words itself; the meaning shall, however, include herein, without limiting the foregoing and unless the context requires otherwise, any numerical or computer-implemented description of the past, present, or future state of something.

Throughout this specification the term “correlating to a corresponding spatial surface” and derivative or similar terms shall be understood as being generic to all possible meanings supported by the specification and by the words itself; the meaning shall, however, include herein, without limiting the foregoing and unless the context requires otherwise, one or more of: substantially matching a similar spatial shape of a corresponding spatial surface, substantially matching a similar spatial shape of a dimensionally reduced virtual representation of a corresponding spatial surface, substantially matching a similar spatial shape of a dimensionally expanded virtual representation of a corresponding spatial surface, substantially matching a similar spatial shape of an undersized virtual representation of a corresponding spatial surface, and/or substantially matching a similar spatial shape of an oversized virtual representation of a corresponding spatial surface.

Throughout this specification the term “substantial spatial extension” and derivative or similar terms shall be understood as being generic to all possible meanings supported by the specification and by the words itself; the meaning shall, however, include herein, without limiting the foregoing and unless the context requires otherwise, any spatial extension that is not nonmaterial when compared to the spatial extension of interest of the reference object or implementation.

Throughout this specification the term “surface” and derivative or similar words shall be understood as being generic to all possible meanings supported by the specification and by the words itself; the meaning shall, however, include herein, without limiting the foregoing and unless the context requires otherwise, one or more of: an outside of a physical body, a virtual surface, a numerical representation of a surface, a virtual outside of a numerical representation of a body, a transitional surface boundary, a physical shape contour, and/or a physical edge contour. As it relates to the terms “a virtual surface” and/or “a numerical representation of a surface” and derivative or similar terms, it should be understood that those surfaces have no inside or outside per se, to the extent that an inverse surface to such surface would be identical to such surface itself.

Throughout this specification the term “spatial” and derivative or similar words shall be understood as being generic to all possible meanings supported by the specification and by the words itself; the meaning shall, however, include herein, without limiting the foregoing and unless the context requires otherwise, one or more of: three-dimensional, relating to or occupying space, non-linear, non-planar, and/or being of natural physical real and non-mathematical shape.

Throughout this specification the term “patient” and derivative or similar words shall be understood as being generic to all possible meanings supported by the specification and by the words itself; the meaning shall, however, include herein, without limiting the foregoing and unless the context requires otherwise, a human subjected to a diagnostic exercise and/or undergoing a medical treatment, or subjected to a potential anticipated diagnostic exercise and/or a potential anticipated medical treatment.

Throughout this specification the term “custom-shaped” and derivative or similar words shall be understood as being generic to all possible meanings supported by the specification and by the words itself; the meaning shall, however, include herein, without limiting the foregoing and unless the context requires otherwise, a reference to a shape of the object of interest of substantial spatial extension correlating to a corresponding spatial surface of a past, present, future, or projected state of an anatomy of a pre-identified individual patient.

Throughout this specification the word “aligner” and derivative or similar words shall be understood as being generic to all possible meanings supported by the specification and by the words itself; the meaning shall, however, include herein, without limiting the foregoing and unless the context requires otherwise, a custom-shaped orthodontic aligner.

Throughout this specification the word “expander” and derivative or similar words shall be understood as being generic to all possible meanings supported by the specification and by the words itself; the meaning shall, however, include herein, without limiting the foregoing and unless the context requires otherwise, a custom-shaped orthodontic expander.

Throughout this specification the term “transversal” and derivative or similar words shall be understood as being generic to all possible meanings supported by the specification and by the words itself; the meaning shall, however, include herein, without limiting the foregoing and unless the context requires otherwise, a line that intersects a system of lines, and in the context of an orthodontic treatment any direction that has a component perpendicular to the sagittal, e.g., the antero-posterior axis and a component perpendicular to the vertical axis of a human head.

Throughout this specification the term “orthodontic en masse movement” and derivative or similar words shall be understood as being generic to all possible meanings supported by the specification and by the words itself; the meaning shall, however, include herein, The movement of a group of adjacent teeth with a significant component of movement in a substantially same direction, orientation, and/or inclination.

Throughout this specification the term “non-transitory processor-readable medium” and/or “statutory processor-readable medium” and derivative or similar words shall be understood herein as being generic to all possible meanings supported by the specification and by the words itself; provided, however, that the meaning shall include any processor-readable memory or non-transitory computer data signal except any non-patent-eligible subject matter as defined in the applicable jurisdiction by the then applicable law and case law as being not patentable; by way of example, and not limitation, in the United States at the time of this disclosure any processor-readable medium except a transitory, propagating signal, which is not physical, transferrable and reproducible.

Throughout this specification the term “processor-readable memory” and derivative or similar words shall be understood herein as being generic to all possible meanings supported by the specification and by the words itself; the meaning shall, however, include, without limiting the foregoing and unless the context requires otherwise, any medium that can store or transfer information, by way of example, and not limitation, any dynamic, static, read/write, read-only, sequential-access, location-addressable, file-addressable, and/or content-addressable storage device, register memory, processor cache and RAM, any semiconductor memory device, ROM, flash memory, erasable ROM, EPROM, EEPROM, flash memory, or other solid state memory technology, floppy diskette, CD-ROM, digital versatile disks, DVD, HD-DVD, BLU-RAY disc, magnetic memory, optical disk, magnetic cassettes, magnetic tape, magnetic disk, or other magnetic storage devices, hard disk, MRAM, and/or like device.

Throughout this specification the term “non-transitory computer data signal” and or “statutory computer data signal” and derivative or similar words shall be understood herein as being generic to all possible meanings supported by the specification and by the words itself; provided, however, that the meaning shall include any computer data signal except any non-statutory subject matter as defined in the applicable jurisdiction by the then applicable law and case law as being not patentable, by way of example, and not limitation, in the United States at the time of this disclosure any physical, transferrable and reproducible computer data signal. Such non-transitory computer data signals can include, by example and not limitation, data transmitted in blocks, followed by a check of the integrity of the receiver's data, so that, if there is a single bit error, the entire block has to retransmit until the reproducibility has been guaranteed (e.g., “error correction”).

Throughout this specification the term “computer data signal” and derivative or similar words shall be understood herein as being generic to all possible meanings supported by the specification and by the words itself; the meaning shall, however, include, without limiting the foregoing and unless the context requires otherwise, any signal that can propagate encoded information such as computer readable instructions, encoded logic, data structures, program modules, or other data over a transmission medium, other transport mechanisms, or delivery media such as a carrier wave, parallel or serial computer bus systems, electronic network channels, optical fibers, air, infrared, acoustic or electromagnetic paths, RF links or other wired or wireless configurations, by way of example, and not limitation, computer networks such as the internet, intranet, LAN, serial or parallel bus systems, or otherwise, supported by network connectivity devices that may take the form of modems, modem banks, Ethernet cards, Universal Serial Bus (USB) interface cards, serial interfaces, token ring cards, fiber distributed data interface (FDDI) cards, wireless local area network (WLAN) cards, radio transceiver cards, and/or other like network connectivity devices. The network connectivity devices may provide wired communication links and/or wireless communication links. Wired communication links may be provided in accordance with Ethernet (IEEE 802.3), Internet protocol (IP), time division multiplex (TDM), data over cable service interface specification (DOCSIS), wavelength division multiplexing (WDM), and/or the like. Radio transceiver cards may provide wireless communication links using protocols such as code division multiple access (CDMA), Global System for Mobile Communications (GSM), LTE, WI-FI (IEEE 802.11), BLUETOOTH, ZIGBEE, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices may enable a processor or processors to communicate with the Internet or one or more intranets. With such a network connection, it is contemplated that a processor or processors might receive information from the network and/or might output information to the network. Such information, which is often represented as a sequence of instructions to be executed using a processor or processors, may be received from and/or outputted to the network, for example, in the form of a computer data signal embodied in a carrier wave.

Throughout this specification the term “user interface control”, “UI control”, and derivative or similar words shall be understood as being generic to all possible meanings supported by the specification and by the words itself; the meaning shall, however, include herein, without limiting the foregoing and unless the context requires otherwise, one or more of: an input control, an editable text input control, a button control, a drop-down menu, a combo box, a radio button control, a checkbox control, an accordion control, a link, a tab control, a breadcrumbs control, a tree pane control, a menu control, a tool tip control, an icon control, an acoustic control, and/or a gesture control.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein can be code segments or instructions that perform the various tasks. The program or code segments can be stored in a processor-readable medium or transmitted by a computer data signal embodied in a carrier wave over a transmission medium or communication path. In this regard, the subject matter described herein can be implemented in the context of any computer-implemented system and/or in connection with two or more separate and distinct computer-implemented systems that cooperate and communicate with one another.

Some objectives of the disclosed technology include enabling the avoidance of interproximal reduction (IPR) in the context of orthodontic aligner treatments. IPR is often promoted in the context of an orthodontic aligner treatment of healthy teeth subjected to such treatment, yet, as a technical problem, performing IPR on healthy teeth can undermine the integrity and long-term prognosis of such shaved teeth. Furthermore, systems disclosed herein can concurrently and efficiently provide alignment of teeth and orthodontic en masse movements expanding posterior teeth within a jaw of a patient with or without the option to concurrently resolve orthodontic deep bite issues by using easily removable appliances. Related computer program products methods and systems in the field of orthodontics to efficiently assist such treatment are further disclosed.

The system(s) and method(s) provided by the various embodiments of the present technology comprise several independent novel and nonobvious features providing substantial improvements. The greatest benefit can be achieved in the field of removable orthodontic appliances moving teeth in the context of an orthodontic treatment and of the computer-aided planning of orthodontic treatments and the computer-aided design and manufacturing of such orthodontic appliances.

One or more of the objects and/or features described in this, the preceding and the following paragraph(s) may be combined in any combination and in no or in any order. One or more of the method, process and/or function steps described in this, the preceding and the following paragraph(s) may be combined in any combination and in no or in any order. One or more of the objects described in this, the preceding and the following paragraph(s) may be configured to carry out one or more of the method, process and/or function steps disclosed in this, the preceding and the following paragraph(s) in any combination and in no or in any order.

FIG. 1 shows several occlusal illustrations of an exemplary embodiment of a system to assist in an orthodontic treatment of a patient comprising an orthodontic aligner and an orthodontic expander in accordance with one or more embodiments of the present technology.

The three illustrations in occlusal view of the same or similar upper jaw 100, 130, and 160 of a patient undergoing orthodontic treatment in FIG. 1 show in one or more exemplary embodiments of the present technology the same or similar gingiva 110, 140, and 170, the same or similar palate 112, 142, and 172, and the same or similar plurality of teeth 115, 145, and 175 of the patient undergoing orthodontic treatment, the same or similar custom-shaped orthodontic aligner 150, and 180, or the same of similar plurality of aligners 150, and 180, that can be successively inserted or removed by the patient in the course of the orthodontic treatment and a detachable custom-shaped orthodontic expander 190 that can be also inserted or removed by the patient in the course of the orthodontic treatment. The illustration 100 shows in an exemplary embodiment of the present technology the upper jaw of the patient comprising the gingiva 110, the palate 112, and the plurality of teeth 115 subjected to the orthodontic treatment. The illustration 130 shows in another exemplary embodiment of the present technology the upper jaw of the patient comprising the gingiva 140, the palate 142, and the plurality of teeth 145 subjected to the orthodontic treatment, and an inserted aligner 150 or a plurality of aligner 150 successively inserted. The illustration 160 shows in yet another exemplary embodiment of the present technology the upper jaw of the patient comprising the gingiva 170, the palate 172, and the plurality of teeth 175 subjected to the orthodontic treatment, an inserted aligner 180 or a plurality of aligner 180 successively inserted, and the expander 190, operationally inserted and attached to inserted aligner 180 or a plurality of aligner 180 successively inserted.

Further, the three illustrations in occlusal view of the same or similar lower jaw 100, 130, and 160 of a patient undergoing orthodontic treatment in FIG. 1 show an additional one or more exemplary embodiments of the present technology the same or similar gingiva 110, 140, and 170, the same or similar lingual gingival mandibular anatomy 112, 142, and 172, and the same or similar plurality of teeth 115, 145, and 175 of the patient, the same or similar aligner 150, and 180, or the same of similar plurality of aligners 150, and 180, that can be successively inserted or removed by the patient in the course of the orthodontic treatment and a detachable expander 190 that can be also inserted or removed by the patient in the course of the orthodontic treatment. The illustration 100 shows in an exemplary embodiment of the present technology the lower jaw of the patient comprising the gingiva 110, the lingual gingival mandibular anatomy 112, and the plurality of teeth 115 subjected to the orthodontic treatment. The illustration 130 shows in another exemplary embodiment of the present technology the lower jaw of the patient comprising the gingiva 140, the lingual gingival mandibular anatomy 142, and the plurality of teeth 145 subjected to the orthodontic treatment, and an inserted aligner 150 or a plurality of aligner 150 successively inserted. The illustration 160 shows in yet another exemplary embodiment of the present technology the lower jaw of the patient comprising the gingiva 170, the lingual gingival mandibular anatomy 172, and the plurality of teeth 175 subjected to the orthodontic treatment, an inserted aligner 180 or a plurality of aligner 180 successively inserted, and the expander 190, operationally inserted and attached to inserted aligner 180 or a plurality of aligner 180 successively inserted.

Each aligner 150, and 180 may be a finished manufactured product prior to its insertion. The aligner 150, and 180 may have multiple teeth-receiving cavities. Each aligner 150, and 180 of the appropriate sequencing stage may be snapped onto the teeth 115, 145, and 175 of a patient's dentition, so that the elastic deformation may create a force field to move the teeth 115, 145, and 175. In one or more exemplary embodiments of the present technology the plurality of aligners 150, and 180 are configured to progressively reposition a plurality of teeth 115, 145, and 175 of a dental jaw of the patient during the orthodontic treatment when successively and operationally positioned. To increase the control of the snap fit of the aligner 150, and 180 with respect to the individual teeth 115, 145, and 175, engagers or attachments may be bonded to augment the shape of the crown of a patient's tooth or teeth 115, 145, and 175, and may provide undercuts and/or a geometrical shape of the crown that is rotationally asymmetrical.

In an exemplary embodiment of the present technology, after the initial consultation between the patient and the dentist or dental specialist, a method including a manufacturing process may start with a dental professional taking a silicon impression of the patients upper and lower jaw and a wax bite registration and may submit the impressions and the wax bite together with a prescription form, where the treating dentist or dental specialist may outline the orthodontic treatment plan and the details for the patient-individual target tooth arrangement, to a dental laboratory. The orthodontic treatment plan may anticipate the transformation of the patient's dentition from its beginning configuration to one or more intermediate configuration(s), and then to a final configuration of reasonable target occlusion. At the dental laboratory, a technician may disinfect the impressions and the wax bite, may pour dental gypsum or plaster into the impressions and, after hardening, may trim the hardened gypsum or plaster to prepare orthodontic models, or so-called stone or gypsum models representing the current maloccluded positions of the patient's teeth 115, 145, and 175.

Further, the dental technician may place the stone models into a dental articulator (e.g. SAM 3, SAM Articulator System, SAM Präzisionstechnik GmbH, Gauting, Germany) may use the wax bite to position the upper jaw and lower jaw stone models in a close to correct or correct upper and lower jaw relationship or intercuspation and may use clinical judgement or other measurements provided by the dental office to position the upper jaw and lower jaw stone models within the articulator in a close to correct or correct anatomical orientation to simulate the temporomandibular joint (TMJ) and upper anterior teeth guidance. The dental technician may then detach the stone or gypsum models with its attachment mechanism from the dental articulator and duplicate them, maintaining the articulated position of the upper and lower jaw stone models, cut out the individual model teeth and reposition the model teeth with dental hard wax (e.g. Base Plate Wax, Kerr, Brea, CA, U.S.A.) repositioning and waxing-up the final configuration of the patient's teeth 115, 145, and 175 in the articulated upper and lower jaw stone models so that they have a reasonable target occlusion, also referred to as the orthodontic set-up or wax-up, as prescribed by the treating dentist or dental specialist.

The dental technician may use a light-curing, blocking-out and modelling putty (e.g. BLUE-BLOKKER, Scheu-Dental GmbH, Iserlohn, Germany) for sealing and blocking the wax-up models to gain stability for subsequent thermoforming processes. The putty may be cured with a curing light device producing light in the wavelength range of 380-470 nm according to manufacturer's specification. Further, the dental technician may use the wax-up model or duplicates thereof, to produce one or more intermediate configuration(s) of the patient's teeth 115, 145, and 175 simulating the course of treatment, based on the material working range for moving teeth per aligner 150, and 180.

The dental technician then may utilize the maloccluded stone or gypsum models, the wax-ups and/or the sealed wax-ups of the intermediate and/or the final configuration(s), or duplicate stone or gypsum models thereof, to thermoform the plurality of aligners 150, and 180, one for each stage for the upper jaw and/or and one for each stage of the lower jaw, as prescribed. The dental technician may use transparent, thermoformable, biocompatible sheets made of polyethylene terephthalate glycol-modified (PET-G), polypropylene, polycarbonate (PC), thermoplastic polyurethanes (TPU), ethylene vinyl acetate, or like materials, or a combination thereof (e.g. Zendura FLX, Bay Materials LLC, Fremont, CA, U.S.A.) utilizing a pressure molding technique and respective apparatus (e.g. Biostar Scan with LCD Display, Great Lakes Dental Technologies, Tonawanda, NY, U.S.A.) according to manufacturers' specifications. For example, the pressure molding apparatus pre-heats the thermoformable sheets, and after positioning the sheet atop the stone or gypsum model in an airtight or close to airtight way as supported by the apparatus, the apparatus will build up a vacuum between the stone model and the pre-heated sheet so that the pressure difference between the ambient atmospheric air pressure and the vacuum sucks down and forms the sheet to match the three-dimensional shape and contours of the stone model, so that, after cooling down, the thermoformable sheet fits the configuration of the teeth 115, 145, and 175 as represented by the respective stone or gypsum model used in the pressure molding process, each having one tooth-receiving cavity per tooth of the model teeth as present in the correlating stone or gypsum model.

During the thermoforming process, the thickness of the sheet material, e.g. 0.5 mm may be stretched and/or compressed differently so that the thickness of the aligner material my vary between 0.3 mm and 0.6 mm. Before the thermoforming process, however, the dental technician may fill in, for example, undercuts, fissures, interproximal spaces with the hard dental wax mentioned before so that such areas may be blocked out and may not be exactly reproduced in their respective details by the pressure molding process. In the same manner the dental technician may adhesively attach to the stone or gypsum models preformed engagers and/or preformed protrusions or respective other shape representations or build up on the stone or gypsum models such engagers and/or protrusions or respective other shape representations with dental hard wax or composite so that an inverse form of the engager shape and/or correlating shapes of the protrusions or respective other shape representations are part of the thermoformed aligner 150, and 180 after the pressure molding process.

After thermoforming the aligner 150, and 180, the dental technician may cut and trim the aligner 150, and 180 to remove the excess material of the original sheet so that a trimming line is contoured and positioned adjacent the gingival margin 110, 140, and 170 of the patient when each such aligner 150, and 180 is operationally positioned on the teeth 115, 145, and 175 of the respective jaw of the patient.

The engagers may be designed and fabricated to increase the grip of the tooth-receiving cavity of the aligner 150, and 180 with the crown of the correlating tooth, when operationally positioned, after the patient may have received correlating engagers bonded or build up with dental composite at a correlating position and a correlating inclination on the crowns of the respective teeth, included in the plurality of teeth 115, 145, and 175. To bond or build-up such engagers, the dental technician may have thermoformed a respective engager bonding template using the first stone or gypsum model of the stages where the treatment plan calls for engagers, using the same or similar pressure molding technique as described above but using a more suitable material (e.g. Zendura A, Bay Materials LLC, Fremont, CA, U.S.A.). Each aligner 150, and 180 of the appropriate sequencing stage may be snapped onto a correlating jaw of the patient's dentition, so that the elastic deformation may create a force field to move the plurality of teeth 115, 145, and 175. Each aligner 150, and 180 may allow to move the teeth 115, 145, and 175 incrementally. The series of aligners 150, and 180 may be designed and made to achieve the treatment goal.

The expander 190 may be a finished manufactured product prior to its insertion. The patient may be educated and instructed to progressively turn a screw with right- and left-hand threads that is often the center element of the expanding mechanism 194 so that two respectively threaded adapters of the expanding mechanism 194 may move apart.

In one or more exemplary embodiments of the present technology, a custom-shaped orthodontic expander 190 is configured to apply a transversal force to widen a dimensional distance between a plurality of right posterior teeth of the plurality of teeth 115, 145, and 175 and a plurality of left posterior teeth of the plurality of teeth 115, 145, and 175 of a certain jaw of the patient during the orthodontic treatment when operationally positioned between the plurality of right posterior teeth and the plurality of left posterior teeth. The expander 190 may be removable and custom-shaped, and each aligner 150, and 180 of the plurality of aligners 150, and 180 may be removable and custom-shaped and the expander 190 and each aligner 150, and 180 of the plurality of aligners 150, and 180 may be individually designed and individually manufactured for a certain jaw for a certain patient, and configured so that the expander 190 and each successively used aligner 150, and 180 of the plurality of aligners 150, and 180 may be attached by the patient to become operationally positioned and attached or respectively detached and removed by the patient. For example, the expander 190 in combination with each aligner 150, and 180 of the plurality of aligners 150, and 180 may have a right form-lock interface 195 and a left form-lock interface 195 and, when operationally so combined during the orthodontic treatment, may be configured that each such aligner 150, and 180 operationally positions and holds the expander 190 and acts as an intermediary to translate the transversal force onto the plurality of right posterior teeth and the plurality of left posterior teeth of the plurality of teeth 115, 145, and 175. The so translated transversal force may cause and support an orthodontic en masse movement of the plurality of right posterior teeth of the plurality of teeth 115, 145, and 175 on one hand and the plurality of left posterior teeth of the plurality of teeth 115, 145, and 175 of the other hand widening the dimensional transversal distance therebetween. Further, for example, the expander 190 is, when operationally inserted, positioned and held by a right and a left form-lock interface 195 between the expander 190 and the same or similar aligners 150, and 180. The form-lock interface 195 may be configured so that at least two of male/female connectors form a detachable click-in mechanism between the expander 190 and the same or similar aligners 150, and 180.

In yet another exemplary embodiment of the present technology, the same or similar aligners 150, and 180 of the plurality of aligners 150, and 180 may be configured to compensate for the transversal forces the expander 190 may express when operationally combined with the same or similar aligners 150, and 180 and operationally positioned. For example, the transversal forces may act on a vertical height adjacent the crowns of the posterior teeth of the plurality of teeth 115, 145, and 175 while the center of resistance of these teeth are on root height, which may cause the posterior teeth of the plurality of teeth 115, 145, and 175 to incline outwards. However, the same or similar aligners 150, and 180 so combined may provide a compensating force to upright the so affected posterior teeth of the plurality of teeth 115, 145, and 175 resulting in a bodily transversal movement as planned to avoid the outwards inclination as a side effect.

In yet another embodiment of the present technology, the expander 190 has a right and a left expander body 192, and 193, and.or an expanding mechanism 194, also referred to as an expansion screw 194. A Universal Expansion Screw 100-2000 (stainless steel) or a 100T2000 (titanium) expansion screw (e.g., Forestadent, Bernhard Förster GmbH, Germany) may be used as expanding mechanism 194, each side of the expanding mechanism 194 being embedded in an acrylic polymer/monomer dental resin mix (e.g. Splint Resin Acrylic Kit, Great Lakes Dental Technologies, Tonawanda, NY, U.S.A.). The dental technician fabricating the expander 190 may use the initial malocclusion stone or gypsum model or one of the first intermediate stone or gypsum models as described above and, for example, a duplicate of the correlating aligner 150, and 180 as tools to fabricate the expander 190. Alternatively, the dental technician may thermoform the same sheet material that is used to make the aligner, or a thermoformable sheet material of similar thickness on the initial malocclusion stone or gypsum model or one of the first intermediate stone or gypsum models utilized to make the expander.

That duplicate of the aligner, or the thermoformed sheet may serve as a tool in the subsequent process steps to geometrically represent the thickness of the correlating same or similar aligners 150, and 180 in the area of the interface between the same or similar aligners 150, and 180 and/or to isolate the resin building up the aligner from the stone or gypsum model used. The duplicate of the correlating aligner 150, and 180 or the thermoformed sheet may be placed atop of the malocclusion stone or gypsum model. The dental technician may place and affix the expansion screw 194 with dental hard wax onto the stone or gypsum model, may further block out undercuts, fissures and may build-up and/or model in case of an upper jaw expander 190 a space between the palate 112, 142, and 172, or in case of a lower jaw expander 190 a space between the lingual gingival mandibular anatomy 112, 142, and 172 respectively and the anticipated shape of the expander 190 using permanent plastic silicone (e.g. SIL-KITT red, Scheu-Dental GmbH, Iserlohn, Germany). The expander-facing surface of the build-up of the permanent plastic silicone on the stone or gypsum model configured to make the upper jaw expander 190 may correlate to the anatomical three-dimensional surface of the stone or gypsum model representing the palate 112, 142, and 172 of the patient and therefore may correlate to the anatomical three-dimensional surface of the palate 112, 142, and 172 of the patient. The expander-facing surface of the build-up of the permanent plastic silicone on the stone or gypsum model configured to make the lower jaw expander 190 may correlate to the anatomical three-dimensional surface of the stone or gypsum model representing the lingual gingival mandibular anatomy 112, 142, and 172 of the patient and, therefore, may correlate to the anatomical three-dimensional surface of the lingual gingival mandibular anatomy 112, 142, and 172 of the patient.

The dental technician may then build-up the acrylic polymer/monomer dental resin mix embedding the expanding mechanism 194 and forming the anticipated volume and shape of the right and left expander bodies 192, and 193 using the so prepared stone or gypsum model as a tool and template in a so-called salt and pepper technique. The build-up on the so prepared stone or gypsum model may be hardened by pressure-polymerization in a temperature pressure pot (e.g. Great Lakes 6 Liter Adjustable Temperature Pressure Pot, Great Lakes Dental Technologies, Tonawanda, NY, U.S.A.) at approximately 45° C. (range 40° C. to 50° C.) at approximately 2 bar (range 1.5 bar to 2.5 bar) for about 20 minutes (range 5 to 90 minutes). The so hardened acrylic build up with the embedded expanding mechanism 194 may be separated from the template and may be segmented using a manual saw or a separating disc adjacent midline and around the center of the expanding mechanism 194, and may be manually trimmed and polished to its final shape to thereby creating the expander bodies 192, and 193 mounted together with the expanding mechanism 194 so that turning the center screw expanding mechanism 194 moves the expander bodies 192, and 193 apart or closer toward each other. As part of this process, and as the duplicate of the correlating aligner 150, and 180 or the thermoformed sheet may have been used atop of the malocclusion stone or gypsum model used in the process, the expander bodies 192, and 193 may have been formed against the lingual (tongue side) surface of the duplicate of the correlating aligner 150, and 180 or the correlating area of thermoformed sheet forming an inverse shape of the portion of the right form-lock interface 195 and of the left form-lock interface 195 as specifically prepared. For example, as a build-up correlating to a male portion of the right form-lock interface 195 and a build-up of a correlating male portion of the left form-lock interface 195 by the dental technician on the stone or gypsum model used in the process that becomes subsequently translated onto the duplicate of the correlating aligner 150, and 180 or the thermoformed sheet by the thermoforming process as described above. The palate-facing surface of upper jaw expander 190 may correlate to the anatomical three-dimensional surface of the palate 112, 142, and 172 of the patient. The surface of the lower jaw expander 190 that faces the lingual gingival mandibular anatomy 112, 142, and 172 may correlate to the anatomical three-dimensional surface of the lingual gingival mandibular anatomy 112, 142, and 172 of the patient.

In another exemplary embodiment of the present technology, the plurality of aligners 150, and 180 having different teeth-receiving cavity geometries based on successive intermediate arrangements of the plurality of right posterior teeth of the plurality of teeth 115, 145, and 175, and the geometries are selected to progressively substantially reposition the plurality of right posterior teeth of the plurality of teeth 115, 145, and 175 against each other during the orthodontic treatment when successively and operationally positioned. In this case, the right form-lock interface 195 on the lingual side of each such same or similar aligner 150, and 180 successively used, is configured to be maintained in the same or similar shape and independent of the geometry changes of the lingual portion of the successively used aligners 150, and 180 caused by the different teeth-receiving cavity geometries based on the successive intermediate changing arrangements of the plurality of right posterior teeth of the plurality of teeth 115, 145, and 175. In other words, in this case, for example, the geometry of the aligner side forming the right form-lock interface 195 can be substantially constant, despite the changes of the teeth-receiving cavity geometries of the same or similar aligners 150, and 180 adjacent the right posterior teeth to be moved.

In yet another exemplary embodiment of the present technology, the plurality of aligners 150, and 180 having different teeth-receiving cavity geometries based on successive intermediate arrangements of the plurality of left posterior teeth of the plurality of teeth 115, 145, and 175, and the geometries are selected to progressively substantially reposition the plurality of left posterior teeth of the plurality of teeth 115, 145, and 175 against each other during the orthodontic treatment when successively and operationally positioned. In this case the left form-lock interface 195 on the lingual side of the same or similar aligners 150, and 180, as successively used, is configured to be maintained in the same or similar shape and independent with respect to the geometry changes of the lingual portion of the successively used aligners 150, and 180 caused by the different teeth-receiving cavity geometries based on the successive intermediate changing arrangements of the plurality of left posterior teeth of the plurality of teeth 115, 145, and 175. In other words, in this case, for example, the geometry of the aligner side forming the left form-lock interface 195 can be substantially constant, despite the changes of the teeth-receiving cavity geometries of the same or similar aligners 150, and 180 adjacent the left posterior teeth to be moved.

In one or more exemplary embodiments of the present technology, the impression(s) taken from the upper jaw and/or the lower jaw, the stone or gypsum model(s), and/or the bite registration of the patient may be digitized in the dental laboratory using, for example, a desktop 3D scanner, or an industrial computer tomography (CT) device, to be represented by correlating three-dimensional image data. In one or more other exemplary embodiments of the present technology, the dental anatomy of the upper jaw and/or the lower jaw and/or the bite may be taken digitally in its entirety, using an intraoral scanner, or a 3D X-ray (e.g. a cone beam computed tomography, CBCT) device to be represented by correlating three-dimensional image data. Each such three-dimensional image data may be used for further processing.

In yet one or more other exemplary embodiments of the present technology, the aligner 150, and 180, the first, the intermediate and the final orthodontic model (as described above) to thermoform the aligner 150, and 180, the expander 190, the duplicate of the correlating aligner 150, and 180 or the thermoformed sheet used (as described above) can be used as a template or tool to build-up the expander 190, and/or the right and left expander bodies 192, and 193, the right and left expander bodies 192, and 193. Each separately or in any combination may be designed and/or modified in the computer by computer aided design (CAD) software components or functionality. Each such design(s) may be responsive to the there-dimensional image data described in the preceding paragraph. The resulting designs of any of said objects, separately or in any combination, in each's respective entirety or in part, may be prepared for production by computer aided manufacturing (CAM) software or functionality, and any of said objects, separately or in any combination may be formed, shaped and/or otherwise manufactured, in each's respective entirety or in part, by direct or indirect manufacturing technologies, and/or by primary, forming, additive and/or subtractive manufacturing and/or shaping and/or shape forming technologies.

In this context, respective computerized numerical controlled (CNC) machinery may be utilized, either in stand-alone configurations, in industry 3.0 utilizing automation and robotics, and/or in industry 4.0 smart factory environments. The CAM data, and/or CNC data may be representative or descriptive of the respective designs of any of said objects, separately or in any combination, in each's respective entirety or in part. Additive manufacturing and/or additive shaping technologies may include rapid prototyping technologies and/or 3D printers, where, for example, material is disposed layer-by-layer to be cured, hardened and/or sintered, while uncured, unhardened, or un-sintered material excess may be removed. Other technologies such as injection molding may be employed. The term “rapid prototyping” in this context shall include but not be limited to manufacturing technologies based on the digital data, by a process that includes depositing material, in accordance with the digital data, layer-by-layer in a plurality of layers each constituting a two-dimensional cross section of a solid object having an edge defined by data of the three-dimensional surface, the layers being stacked in a third dimension to form the solid object having a three-dimensional surface defined by the data. All such rapid prototyping technologies can be used directly to manufacture the part of interest, for example, by selective laser sintering or indirectly by fabricating first, e.g., a resin or wax sample of the part of interest and second using, for example, a “lost-wax” casing technology to duplicate such sample and fabricate thereby the part of interest.

The aforementioned processes may include sintering processes where a “green” body is 3D printed in response to computerized numerical controlled (CNC) data and then sintered to its final material properties. Sintering in this context may include pressure and heat. Further, the meaning of “rapid prototyping” shall be used in its broadest technical sense, where individualized parts are made from virtual representations, and shall include respective primary, additive, subtractive and other forming technologies used to three-dimensionally shape work pieces. The meaning of “additive shaping” shall include but shall not be limited to selective laser melting, selective laser sintering, stereo-lithography, 3D printing or depositing of wax, wax-bound powders, adhesive-bound powders, or slurries. The meaning of “subtractive shaping” shall include but shall not be limited to CNC grinding, CNC turning, CNC laser or water cutting or shaping, CNC milling technologies, and/or other machining and finishing technologies. The meaning of “shape forming” shall include but shall not be limited to near net-shape forming technologies, CNC stamping, and CNC pressing and casting technologies. All manufacturing equipment may be based on multi-axis, e.g. 5-axis operations. In yet another embodiment, a rapid prototyping process may be used for fabricating such objects from hybrid materials.

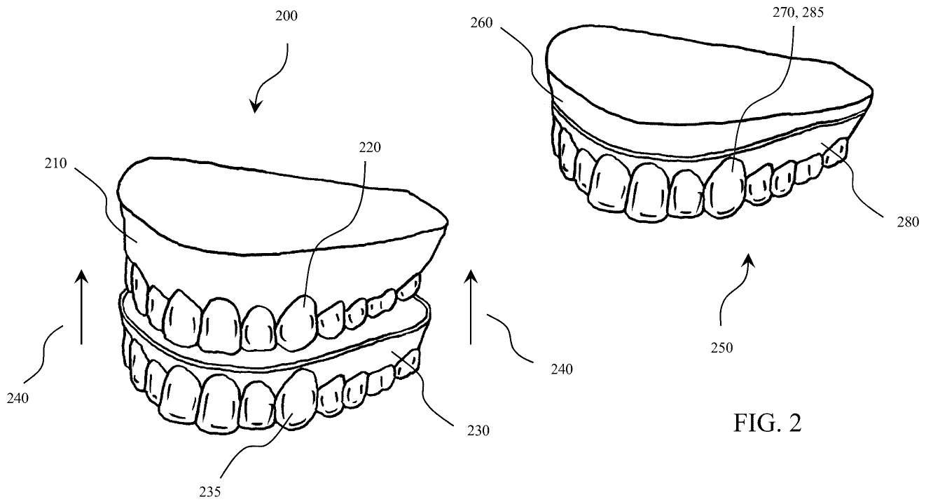

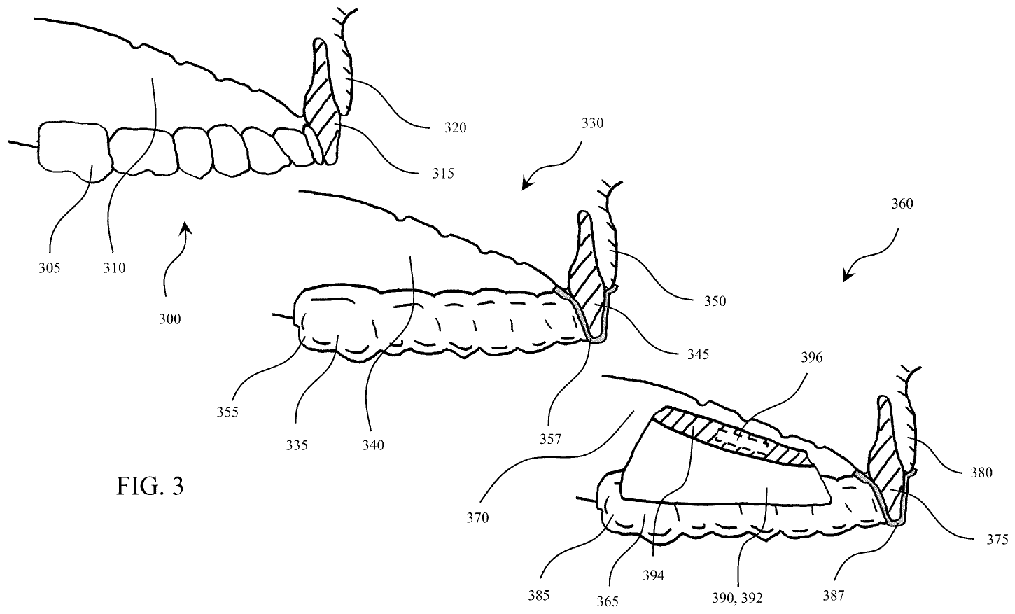

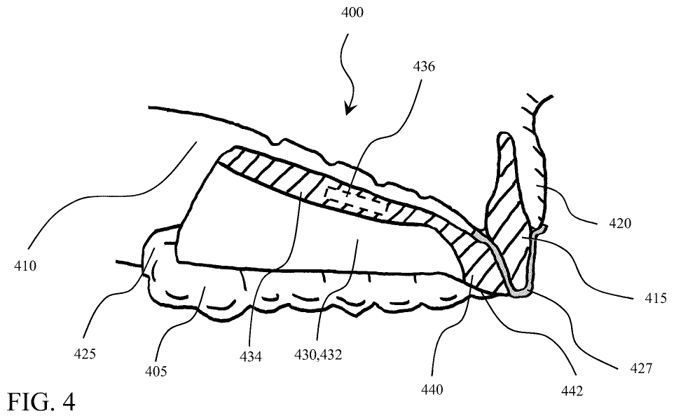

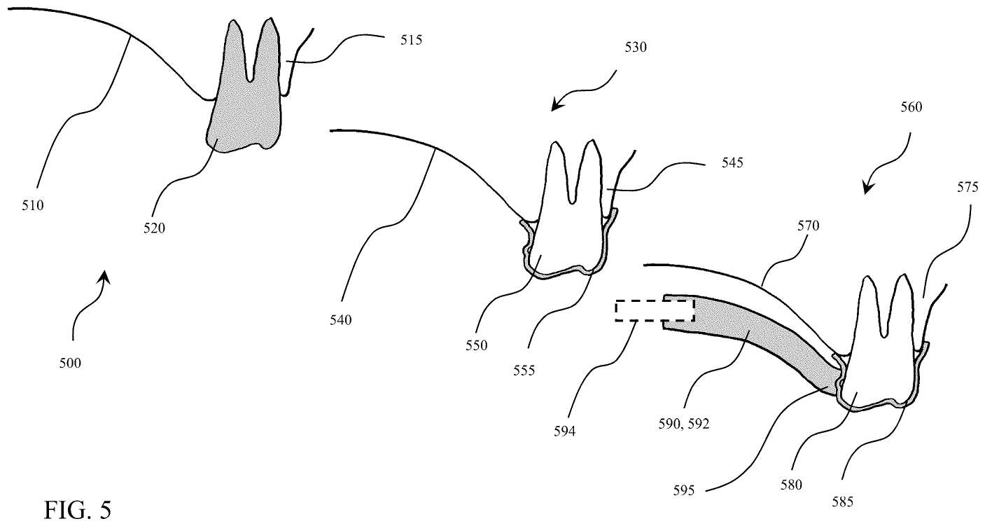

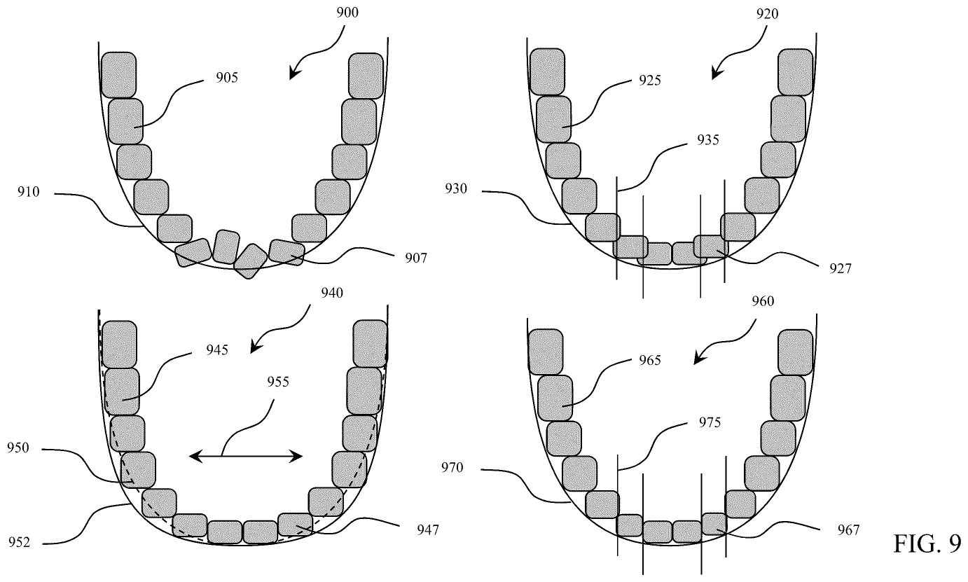

Some examples of the detail A 198 of the form-lock interface 195 between the aligner 150, and 180, or the plurality of aligner 150, and 180 and the expander 190 are shown also in FIG. 8. See further, for example, FIG. 2, FIG. 3, FIG. 4, FIG. 5, FIG. 8, or any of the FIGS. discussed herein for additional detailed aspects of embodiments of the present technology that can be combined with the objects and/or features shown in reference to FIG. 1, in any combination. The direction of transversal orthodontic en masse movement of posterior teeth described in reference to FIG. 1 may represent the same or similar direction of transversal expansion 955 as shown in and/or described with respect to FIG. 9, and vice versa. The patient and the orthodontic treatment, as each described in reference to FIG. 1 may represent the same or similar patient undergoing orthodontic treatment 1010 as shown in and described with respect to FIG. 10, or any of the FIGS. discussed herein, and vice versa. The upper jaw and/or the lower jaw of the patient undergoing the orthodontic treatment, the gingiva 110, 140, and 170, the palate 112, 142, and 172, the lingual gingival mandibular anatomy 112, 142, and 172, and the plurality of teeth 115, 145, and 175, each as shown in and/or described in reference to FIG. 1 may represent the same or similar upper jaw, lower jaw, gingiva, palate, lingual gingival mandibular anatomy, or plurality of teeth, respectively, as comprised in the dentition 1012 of the patient 1010 subjected to orthodontic treatment as shown in and/or described with respect to FIG. 10, or any of the FIGS. discussed herein, and vice versa. The aligner 150, and 180, the plurality of aligner 150, and 180, the expander 190, and each's details, each as shown in and/or described in reference to FIG. 1 may represent the same or similar aligner, expander, or each's details, respectively, as comprised in the orthodontic appliance 1090 delivered as shown in and/or described with respect to FIG. 10, or any of the FIGS. discussed herein, and vice versa. The intraoral scanner, the 3D image data, the IT configuration, the computer aided design (CAD) hardware and/or software, the computer aided manufacturing (CAM) hardware and/or software, the computerized numerical controlled (CNC) technologies and/or equipment, the additive, subtractive and/or other forming and/or shaping technologies and/or equipment, each as described in reference to FIG. 1 may represent the same or similar hardware, software, machinery, technologies, IT configuration, or data, including but not limited to the handpiece of 3D intraoral scanner 1020, control unit of 3D intraoral scanner 1022, 3D scan data 1024, database 1030, data 1032, 1059, and 1069, internet 1040, personal computer (PC) 1050, and 1060, hardware and software configuration 1055, and 1065, memory 1056, and 1066, processor(s) 1057, and 1067, communications interface 1058, and 1068, computer numerical control (CNC) data 1070, or manufacturing facility and equipment 1080, respectively as shown in and/or described with respect to FIG. 10, or any of the FIGS. discussed herein, and vice versa.

FIG. 2 shows several perspective view illustrations of an exemplary embodiment of an operational placement of an orthodontic aligner in accordance with one or more embodiments of the present technology.

The two illustrations are perspective views of the same or similar upper jaw 200, and 250 of a patient undergoing orthodontic treatment in FIG. 2 show in one or more exemplary embodiments of the present technology the same or similar gingiva 210, and 260, the same or similar plurality of teeth 220, and 270, of the patient and the same or similar aligner 230, and 280 or the same or similar plurality of aligner 230, and 280, having, each (as applicable), the same or similar plurality of teeth-receiving cavities 235, and 285.

Further, the two illustrations in occlusal view of the same or similar lower jaw 200, and 250 of a patient undergoing orthodontic treatment in FIG. 2 show an additional one or more exemplary embodiments of the present technology the same or similar gingiva 210, and 260, the same or similar plurality of teeth 220, and 270, of the patient and the same or similar aligner 230, and 280 or the same or similar plurality of aligner 230, and 280, having, each (as applicable), the same or similar plurality of teeth-receiving cavities 235, and 285.

The illustration of the direction to insert aligner 240, shows, for example, a direction to operationally position the same or similar aligner 230, and 280 or successively the same or similar plurality of aligner 230, and 280 atop of the same or similar plurality of teeth 220, and 270 so that the same or similar plurality of teeth 220, and 270 become placed within the correlating same or similar plurality of teeth-receiving cavities 235, and 285.

The patient and the orthodontic treatment, as each described in reference to FIG. 2 may represent the same or similar patient undergoing orthodontic treatment 1010 as shown in and/or described with respect to FIG. 10, or any of the FIGS. discussed herein, and vice versa. The gingiva 210, and 260, and the plurality of teeth 220, and 270, each as shown in and/or described in reference to FIG. 2 may represent the same or similar upper jaw, lower jaw, gingiva, or plurality of teeth, respectively, as comprised in the dentition 1012 of the patient 1010 subjected to orthodontic treatment as shown in and described with respect to FIG. 10, or any of the FIGS. discussed herein, and vice versa. The aligner 230, and 280, the plurality of aligner 230, and 280 and the plurality of teeth-receiving cavities 235, and 285, each as shown in and/or described in reference to FIG. 2 may represent the same or similar aligner comprised in the orthodontic appliance 1090 delivered as shown in and/or described with respect to FIG. 10, or any of the FIGS. discussed herein, and vice versa.

FIG. 3 shows several lateral cross-sectional view illustrations of an exemplary embodiment of a system to assist in an orthodontic treatment of a patient comprising an orthodontic aligner and an orthodontic expander in accordance with one or more embodiments of the present technology.

The three cross-sectional illustrations in lateral view are of the same or similar portion of an upper jaw 300, 330, and 360 of a patient undergoing orthodontic treatment of the in FIG. 3. Also shown in FIG. 3 are the same or similar gingiva 320, 350, and 380, the same or similar palate 310, 340, and 370, and the same or similar plurality of teeth 305, 335, and 365 of the patient, including, but not limited to, the same or similar upper incisor 315, 345, and 375, the same or similar aligner 355, 357, 385 and 387, or the same or similar plurality of aligners 355, 357, 385, and 387 that can be successively inserted or removed by the patient in the course of the orthodontic treatment, and a detachable expander 390 that can be also inserted or removed by the patient in the course of the orthodontic treatment. The illustration 300 shows in an exemplary embodiment of the present technology the upper jaw of the patient comprising the gingiva 320, the palate 310, and the plurality of teeth 305 subjected to the orthodontic treatment, including, but not limited to, the upper incisor 315 (in cross-sectional view). The illustration 330 shows in another exemplary embodiment of the present technology the upper jaw of the patient comprising the gingiva 350, the palate 340, and the plurality of teeth 335 subjected to the orthodontic treatment, including, but not limited to, the upper incisor 345 (in cross-sectional view), and an inserted aligner 355, and 357 or a plurality of aligner 355, and 357 successively inserted. The illustration 360 shows in yet another exemplary embodiment of the present technology the upper jaw of the patient comprising the gingiva 380, the palate 370, and the plurality of teeth 365 subjected to the orthodontic treatment, including, but not limited to, the upper incisor 375 (in cross-sectional view), an inserted aligner 385, and 387 or a plurality of aligner 385, and 387 successively inserted, and the attached expander 390.

Further, the three cross-sectional illustrations in lateral view of the same or similar lower jaw 300, 330, and 360 of a patient undergoing orthodontic treatment in FIG. 3, where a remaining similar symmetric portion of the lower jaw is outside the view of the cross-sectional illustration, show, in additional, one or more exemplary embodiments with the same or similar gingiva 320, 350, and 380, the same or similar lingual gingival mandibular anatomy 310, 340, and 370, and the same or similar plurality of teeth 305, 335, and 365 of the patient, including, but not limited to, the same or similar lower incisor 315, 345, and 375, the same or similar aligner 355, 357, 385 and 387, or the same of similar plurality of aligners 355, 357, 385, and 387 that can be successively inserted or removed by the patient in the course of the orthodontic treatment, and a detachable expander 390 that can be also inserted or removed by the patient in the course of the orthodontic treatment.

The illustration 300 shows in an exemplary embodiment of the present technology the lower jaw of the patient comprising the gingiva 320, the lingual gingival mandibular anatomy 310, and the plurality of teeth 305 subjected to the orthodontic treatment, including, but not limited to, the lower incisor 315 (in cross-sectional view). The illustration 330 shows in another exemplary embodiment of the present technology the lower jaw of the patient comprising the gingiva 350, the lingual gingival mandibular anatomy 340, and the plurality of teeth 335 subjected to the orthodontic treatment, including, but not limited to, the lower incisor 345 (in cross-sectional view), and an inserted aligner 355, and 357 (in cross-sectional view) or a plurality of aligner 355, and 357 (in cross-sectional view) successively inserted. The illustration 360 shows in yet another exemplary embodiment of the present technology the lower jaw of the patient comprising the gingiva 380, the lingual gingival mandibular anatomy 370, and the plurality of teeth 365 subjected to the orthodontic treatment, including, but not limited to, the lower incisor 375 (in cross-sectional view), an inserted aligner 385, and 387 (in cross-sectional view) or a plurality of aligner 385, and 387 (in cross-sectional view) successively inserted, and the attached expander 390.

For example, the expander 390 has an expander body 392, and an expanding mechanism 396, also referred to as an expansion screw 396. The expander body 392 may have a cross-section 394. Further, for example, the expander 390 is, when operationally inserted, positioned and held by a right and a left form-lock interface between the expander 390 and the same or similar aligner 355, 357 (in cross-sectional view), 385 and 387 (in cross-sectional view), or the same of similar plurality of aligners 355, 357 (in cross-sectional view), 385, and 387 (in cross-sectional view) successively inserted.

See also, for example, FIG. 1, FIG. 2, FIG. 4, FIG. 5, and FIG. 8 for additional detailed aspects of embodiments of the present technology that can be combined with the objects and/or features shown in reference to FIG. 3, in any combination. The patient and the orthodontic treatment, as each described in reference to FIG. 3 may represent the same or similar patient undergoing orthodontic treatment 1010 as shown in and described with respect to FIG. 10, or any FIGS. disclosed herein, and vice versa. The upper jaw and/or the lower jaw of the patient undergoing the orthodontic treatment, the gingiva 320, 350, and 380, the palate 310, 340, and 370, the lingual gingival mandibular anatomy 310, 340, and 370, and the plurality of teeth 305, 335, and 365, each as shown in and/or described in reference to FIG. 3 may represent the same or similar upper jaw, lower jaw, gingiva, palate, lingual gingival mandibular anatomy, and/or plurality of teeth, respectively, comprised in the dentition 1012 of the patient 1010 subjected to orthodontic treatment as shown in and/or described with respect to FIG. 10, or any FIGS. disclosed herein, and vice versa and/or may represent the same or similar gingiva 110, 140, 170, 210, and 260, palate 112, 142, and 172, lingual gingival mandibular anatomy 112, 142, and 172, or plurality of teeth 115, 145, 175, 220, and 270, respectively, each as shown in and/or described with respect to FIG. 1, or FIG. 2, or any FIGS. disclosed herein, respectively, and vice versa. The right and the left form-lock interface described in reference to FIG. 3, may represent the same or similar right form-lock interface 195, or left form-lock interface 195, respectively as shown in and/or described with respect to FIG. 1, or any FIGS. disclosed herein, and vice versa. The aligner 355, and 385, the plurality of aligner 355, and 385, or each's details, each as shown in and/or described in reference to FIG. 3 may represent the same or similar aligner comprised in the orthodontic appliance 1090 delivered as described with respect to FIG. 10, or any FIGS. disclosed herein, and vice versa and/or may represent the same or similar aligner 150, 180, 230, and 280, plurality of aligners 150, 180, 230, and 280, or each's details as shown in and described with respect to FIG. 1, or FIG. 2 respectively, or any FIGS. disclosed herein, and vice versa. The expander 390, and its details, each as shown in and/or described in reference to FIG. 3 may represent the same or similar expander comprised in the orthodontic appliance 1090 delivered as described with respect to FIG. 10, or any FIGS. disclosed herein, and vice versa and/or may represent the same or similar expander 190, and its details as shown in and described with respect to FIG. 1, or any FIGS. disclosed herein, and vice versa.

FIG. 4 shows a lateral cross-sectional view illustration of an exemplary embodiment of a system to assist in an orthodontic treatment of a patient comprising an orthodontic aligner, an orthodontic expander, and a bite plane in accordance with one or more embodiments of the present technology.

The cross-sectional illustration is of a lateral view of the upper jaw 400 of a patient undergoing orthodontic treatment in FIG. 4, where a remaining similar symmetric portion of the upper jaw is outside the view of the cross-sectional illustration, shows in one or more exemplary embodiments of the present technology the gingiva 420, the palate 410, and the plurality of teeth 405 of the patient, including, but not limited to, the upper incisor 415 (in cross-sectional view), the aligner 425, 427 (in cross-sectional view), or the plurality of aligners 425, 427 (in cross-sectional view) that can be successively inserted or removed by the patient in the course of the orthodontic treatment and a detachable expander 430 that can be also inserted or removed by the patient in the course of the orthodontic treatment. For example, the plurality of custom-shaped orthodontic aligners 425, 427 (in cross-sectional view) are configured to progressively reposition the plurality of teeth 405 of the dental jaw of the patient during the orthodontic treatment when successively and operationally positioned.

In another exemplary embodiments of the present technology, the expander 430 has an expander body 432, and an expanding mechanism 436, also referred to as an expansion screw 436. The expander body 432 may have a cross-section 434. Further, for example, the expander 430 is, when operationally inserted, positioned and held by a right and a left form-lock interface between the expander 430 and the aligner 425, 427 (in cross-sectional view), or the plurality of aligners 425, 427 (in cross-sectional view) successively inserted. In another embodiment of the present technology, the expander 430 in combination with each aligner 425, 427 (in cross-sectional view) of the plurality of aligners 425, 427 (in cross-sectional view) forms a plurality of similar right form-lock interfaces and forms a plurality of similar left form-lock interfaces when operationally so combined during the orthodontic treatment so that each said aligner 425, 427 (in cross-sectional view) operationally positions and holds the expander 430 and acts as an intermediary to translate the transversal force onto the plurality of right posterior teeth and the plurality of left posterior teeth.

The core of the custom-shaped dental expander 430 may be a standard mass-produced expansion mechanic unit utilized and, for example, embedded in acrylic segments of the expander, the expander bodies 432 tor expander bodies configured to be moved apart by means of the expansion mechanic unit. In one or more exemplary embodiments of the present technology the custom-shaped orthodontic expander 430 is configured to apply a transversal force to widen a dimensional distance between a plurality of right posterior teeth of the plurality of teeth 405 and a plurality of left posterior teeth of the plurality of teeth 405 of a certain jaw of the patient during the orthodontic treatment when operationally positioned between the plurality of right posterior teeth and the plurality of left posterior teeth.

Further, for example, the expander body 432 has an extension, integral with the expander body 432 that serves as a bite plane portion, comprising a cross-section of bite plane portion 440, and a bite plane 442. In yet another exemplary embodiment of the present technology, the expander 430 comprising at least one extended portion 440 having a bite plane surface 442 configured to intrude a plurality of lower front teeth when operationally positioned.

See also, for example, FIG. 1, FIG. 2, FIG. 3, FIG. 5, FIG. 8, or any of the FIGS. disclosed herein, for additional detailed aspects of embodiments of the present technology that can be combined with the objects and/or features shown in reference to FIG. 4, in any combination. The patient and the orthodontic treatment, as each described in reference to FIG. 4 may represent the same or similar patient undergoing orthodontic treatment 1010 as shown in and described with respect to FIG. 10, or any of the FIGS. disclosed herein, and vice versa. The upper jaw of the patient undergoing the orthodontic treatment, the gingiva 420, the palate 410, and the plurality of teeth 405, each as shown in and/or described in reference to FIG. 4 may represent the same or similar upper jaw, gingiva, palate, and/or plurality of teeth, respectively, comprised in the dentition 1012 of the patient 1010 subjected to orthodontic treatment as shown in and/or described with respect to FIG. 10, or any of the FIGS. disclosed herein, and vice versa and/or may represent the same or similar gingiva 110, 140, 170, 210, 260, 320, 350, and 380, palate 112, 142, 172, 310, 340, and 370, or plurality of teeth 115, 145, 175, 220, 270, 305, 335, and 365, respectively, each as shown in and/or described with respect to FIG. 1, FIG. 2, or FIG. 3, or any of the FIGS. disclosed herein, respectively, and vice versa. The right and the left form-lock interface described in reference to FIG. 4, may represent the same or similar right form-lock interface 195, or left form-lock interface 195, respectively as shown in and/or described with respect to FIG. 1, or FIG. 3 respectively, or any of the FIGS. disclosed herein, and vice versa. The aligner 425, 427 (in cross-sectional view), the plurality of aligner 425, 427 (in cross-sectional view), or each's details, each as shown in and/or described in reference to FIG. 4 may represent the same or similar aligner comprised in the orthodontic appliance 1090 delivered as described with respect to FIG. 10, or any of the FIGS. disclosed herein, and vice versa and/or may represent the same or similar aligner 150, 180, 230, 280, 355, and 385, plurality of aligners 150, 180, 230, 280, 355, and 385, or each's details as shown in and described with respect to FIG. 1, FIG. 2, FIG. 3, or any of the FIGS. disclosed herein, respectively, and vice versa. The expander 430, and its details, each as shown in and/or described in reference to FIG. 4 may represent the same or similar expander comprised in the orthodontic appliance 1090 delivered as described with respect to FIG. 10, or any of the FIGS. disclosed herein, and vice versa and/or may represent the same or similar expander 190, and 390 and its details as shown in and described with respect to FIG. 1, FIG. 3 respectively, or any of the FIGS. disclosed herein, and vice versa.

FIG. 5 shows several frontal cross-sectional view illustrations of an exemplary embodiment of a system to assist in an orthodontic treatment of a patient comprising an orthodontic aligner and an orthodontic expander in accordance with one or more embodiments of the present technology.

The three cross-sectional illustrations are frontal views of the same or similar upper jaw 500, 530, and 560 of a patient undergoing orthodontic treatment in FIG. 5, where a remaining similar symmetric portion of the upper jaw is outside the range of the view of the cross-sectional illustration. Also shown are the same or similar gingiva 515, 545, and 575, the same or similar palate 510, 540, and 570, and the same or similar molar 520, 550, and 580 (each in cross-sectional view), of the plurality of teeth of the patient undergoing, the same or similar custom-shaped orthodontic aligner 555, and 585 (each in cross-sectional view), or the same of similar plurality of aligners 555, and 585 (each in cross-sectional view), that can be successively inserted or removed by the patient in the course of the orthodontic treatment and a detachable custom-shaped orthodontic expander 590 (in cross-sectional view) that can be also inserted or removed by the patient in the course of the orthodontic treatment. The illustration 500 shows an exemplary embodiment of the upper jaw of the patient comprising the gingiva 515, the palate 510, and the molar 520 (in cross-sectional view) of the plurality of teeth subjected to the orthodontic treatment. The illustration 530 shows another exemplary embodiment of the upper jaw of the patient comprising the gingiva 545, the palate 540, and the molar 550 (in cross-sectional view) of the plurality of teeth subjected to the orthodontic treatment, and an inserted aligner 555 (in cross-sectional view) or a plurality of aligner 555 (in cross-sectional view) successively inserted. The illustration 560 shows in yet another exemplary embodiment the upper jaw of the patient comprising the gingiva 575, the palate 570, and the molar 580 (in cross-sectional view) of the plurality of teeth subjected to the orthodontic treatment, an inserted aligner 585 (in cross-sectional view) or a plurality of aligner 585 (in cross-sectional view) successively inserted, and the expander 590 (in cross-sectional view), operationally inserted and attached to inserted aligner 585 (in cross-sectional view) or a plurality of aligner 585 (in cross-sectional view) successively inserted.

In another embodiment, the expander 590 has an expander body 592 (in cross-sectional view), and an expanding mechanism 594, also referred to as an expansion screw 594. Further, for example, the expander 430 is, when operationally inserted, positioned and held by a right and a left form-lock interface 595 between the expander 590 and the aligner 585 (in cross-sectional view), or the plurality of aligners 585 (in cross-sectional view) successively inserted. The expander 590 in combination with each aligner 585 (in cross-sectional view) of the plurality of aligners 585 (in cross-sectional view) may form a plurality of similar right form-lock interfaces 595 and may form a plurality of similar left form-lock interfaces 595 when operationally so combined during the orthodontic treatment so that each said aligner 585 (in cross-sectional view) may operationally position and hold the expander 590 and may act as an intermediary to translate the transversal force onto the plurality of right posterior teeth, including the molar 520, 550, and 580, and the plurality of left posterior teeth, including the molar 520, 550, and 580. The form-lock interface between the expander 590 and each aligner 585 (in cross-sectional view) of the plurality of aligners 585 (in cross-sectional view) may comprise a male connector portion integral with each such aligner 585 (in cross-sectional view) protruding in the direction of the expander body 592, and a female connector portion integral with the expander body 592, formed as an indent to accommodate the male connector portion of each such aligner 585 (in cross-sectional view).

See also, for example, FIG. 1, FIG. 2, FIG. 3, FIG. 4, FIG. 8, or any of the FIGS. disclosed herein, for additional detailed aspects of embodiments of the present technology that can be combined with the objects and/or features shown in reference to FIG. 5, in any combination. The patient and the orthodontic treatment, as each described in reference to FIG. 5 may represent the same or similar patient undergoing orthodontic treatment 1010 as shown in and described with respect to FIG. 10, or any of the FIGS. disclosed herein, and vice versa. The upper jaw and the lower jaw of the patient undergoing the orthodontic treatment, the gingiva 515, 545, and 575, the palate 510, 540, and 570, the lingual gingival mandibular anatomy 510, 540, and 570, and the plurality of teeth, including the molar 520, 550, and 580 (each in cross-sectional view) each as shown in and/or described in reference to FIG. 5 may represent the same or similar upper jaw, lower jaw, gingiva, palate, lingual gingival mandibular anatomy, and/or plurality of teeth, respectively, comprised in the dentition 1012 of the patient 1010 subjected to orthodontic treatment as shown in and/or described with respect to FIG. 10, or any of the FIGS. disclosed herein, and vice versa and/or may represent the same or similar gingiva 110, 140, 170, 210, 260, 320, 350, 380, and 420, palate 112, 142, 172, 310, 340, 370, and 410, lingual gingival mandibular anatomy 112, 142, 172, 310, 340, and 370 or plurality of teeth 115, 145, 175, 220, 270, 305, 335, 365, and 405 (including the molar), respectively, each as shown in and/or described with respect to FIG. 1, FIG. 2, FIG. 3, or FIG. 4 respectively, or any of the FIGS. disclosed herein, and vice versa. The right and the left form-lock interface 595 described in reference to FIG. 5, may represent the same or similar right form-lock interface 195, or left form-lock interface 195, respectively as shown in and/or described with respect to FIG. 1, FIG. 3, or FIG. 4 respectively, or any of the FIGS. disclosed herein, and vice versa. The aligner 555, and 585 (each in cross-sectional view), the plurality of aligner 555, and 585 (each in cross-sectional view), or each's details, each as shown in and/or described in reference to FIG. 5 may represent the same or similar aligner comprised in the orthodontic appliance 1090 delivered as described with respect to FIG. 10, or any of the FIGS. disclosed herein, and vice versa and/or may represent the same or similar aligner 150, 180, 230, 280, 355, 385, 425, and 427 (in cross-sectional view), plurality of aligners 150, 180, 230, 280, 355, 385, 425, and 427 (in cross-sectional view) or each's details as shown in and described with respect to FIG. 1, FIG. 2, FIG. 3, or FIG. 4 respectively, or any of the FIGS. disclosed herein, and vice versa. The expander 590, and its details, each as shown in and/or described in reference to FIG. 5 may represent the same or similar expander comprised in the orthodontic appliance 1090 delivered as described with respect to FIG. 10, or any of the FIGS. disclosed herein, and vice versa and/or may represent the same or similar expander 190, 390, and 430 and its details as shown in and described with respect to FIG. 1, FIG. 3, or FIG. 4 respectively, or any of the FIGS. disclosed herein, and vice versa.

FIG. 6 shows a frontal cross-sectional view illustration of an exemplary embodiment of an augmented or otherwise modified 3D printed jaw model utilized as a tool in a process to manufacture an orthodontic aligner in accordance with one or more embodiments of the present technology.

The cross-sectional illustration is a frontal view 600 in FIG. 6, where a remaining similar symmetric portion of the upper jaw or lower jaw, respectively, is outside the range of the view of the cross-sectional illustration. FIG. 6 shows an embodiment of an augmented or otherwise modified 3D printed upper or lower jaw model 610 (in cross-sectional view) also referred to as a horseshoe 610 (in cross-sectional view) of the printed model of the respective arch of a dentition, that may be used as a tool for manufacturing an aligner 620 (in cross-sectional view) having multiple custom-shaped teeth-receiving cavities to reposition a plurality of teeth of a dental jaw of a patient during the orthodontic treatment when successively and operationally positioned. The aligner 620 (in cross-sectional view) may be formed in a laboratory manufacturing process using a transparent, thermoformable, biocompatible sheets utilizing a pressure molding technique and respective apparatus according to manufacturers' specifications. For example, the pressure molding apparatus pre-heats the thermoformable sheet, and after positioning the sheet atop of the horseshoe 610 (in cross-sectional view) as a forming tool in an airtight or close to airtight way as supported by the apparatus, the apparatus will build up a vacuum between the horseshoe 610 (in cross-sectional view) and the pre-heated sheet so that the ambient atmospheric air pressure sucks down and forms the sheet to match the three-dimensional shape and contours of the horseshoe 610 (in cross-sectional view), so that, after cooling down, the thermoformable sheet fits the configuration of the horseshoe 610 (in cross-sectional view). After further processing, the custom-shaped orthodontic aligner 620 (in cross-sectional view) may be a finished manufactured product prior to its insertion.

The horseshoe 610 may show a protrusion 615 integral with the 3D printed model 610. A virtual representation of the protrusion 610 may be augmented to a virtual model of the horseshoe 610, horseshoe 610 may be 3D printed responsive to that virtual model. The protrusion may be then replicated in the method step custom-forming the aligner 620 (in cross-sectional view) as described in the preceding paragraph to form on its opposite of the aligner sheet material a male connector portion integral with the aligner 620 (in cross-sectional view) comprised in the various exemplary embodiments of a form-lock interface between the aligner 620 (in cross-sectional view) and a detachable custom-shaped orthodontic expander according to various exemplary embodiments of the present technology.

In yet one or more other exemplary embodiments of the present technology, a virtual model of the horseshoe 610 may be combined with a virtual model of the aligner 620 (in cross-sectional view), a respective horseshoe may be 3D printed responsive to the combined virtual model, and the respective horseshoe may be utilized in the process of manufacturing a detachable custom-shaped orthodontic expander according to various exemplary embodiments of the present technology. In this context, the protrusion 615 may be dimensionally enhanced by the virtual aligner sheet material dimension and forms an inverse portion of a female connector portion integral with an expander body comprised in the various exemplary embodiments of a form-lock interface between the aligner 620 (in cross-sectional view) and a detachable custom-shaped orthodontic expander according to various exemplary embodiments of the present technology.

The patient and the orthodontic treatment, as each described in reference to FIG. 6 may represent the same or similar patient undergoing orthodontic treatment 1010 as shown in and described with respect to FIG. 10, or any of the FIGS. disclosed herein, and vice versa. The upper jaw and the lower jaw of the patient undergoing the orthodontic treatment, the palate, the lingual gingival mandibular anatomy, and the plurality of teeth, including a molar in cross-sectional view each as shown in and/or described in reference to FIG. 6 may represent the same or similar upper jaw, lower jaw, gingiva, palate, lingual gingival mandibular anatomy, and/or plurality of teeth, respectively, comprised in the dentition 1012 of the patient 1010 subjected to orthodontic treatment as shown in and/or described with respect to FIG. 10, or any of the FIGS. disclosed herein, and vice versa and/or may represent the same or similar gingiva 110, 140, 170, 210, 260, 320, 350, 380, 420, 515, 545, and 575, palate 112, 142, 172, 310, 340, 370, 410, 510, 540, and 570, lingual gingival mandibular anatomy 112, 142, 172, 310, 340, 370, 510, 540, and 570, or plurality of teeth 115, 145, 175, 220, 270, 305, 335, 365, and 405 (including the molar), respectively, each as shown in and/or described with respect to FIG. 1, FIG. 2, FIG. 3, FIG. 4, or FIG. 5 respectively, or any of the FIGS. disclosed herein, and vice versa. The form-lock interfaces described in reference to FIG. 6, may represent the same or similar form-lock interfaces 195, and 595 as shown in and/or described with respect to FIG. 1, FIG. 3, FIG. 4, or FIG. 5 respectively, or any of the FIGS. disclosed herein, and vice versa. The aligner 620 (in cross-sectional view), or its details, each as shown in and/or described in reference to FIG. 6 may represent the same or similar aligner comprised in the orthodontic appliance 1090 delivered as described with respect to FIG. 10, or any of the FIGS. disclosed herein, and vice versa and/or may represent the same or similar aligner 150, 180, 230, 280, 355, 385, 425, 427 (in cross-sectional view), 555, and 585 (each in cross-sectional view) of the plurality of aligners 150, 180, 230, 280, 355, 385, 425, and 427 (in cross-sectional view) 555, and 585 (each in cross-sectional view) or each's details as shown in and described with respect to FIG. 1, FIG. 2, FIG. 3, FIG. 4, or FIG. 5 respectively, or any of the FIGS. disclosed herein, and vice versa. The expander, and its details, each as shown in and/or described in reference to FIG. 6 may represent the same or similar expander comprised in the orthodontic appliance 1090 delivered as described with respect to FIG. 10, or any of the FIGS. disclosed herein, and vice versa and/or may represent the same or similar expander 190, 390, 430, and 590 and its details as shown in and described with respect to FIG. 1, FIG. 3, FIG. 4, or FIG. 5 respectively, or any of the FIGS. disclosed herein, and vice versa.

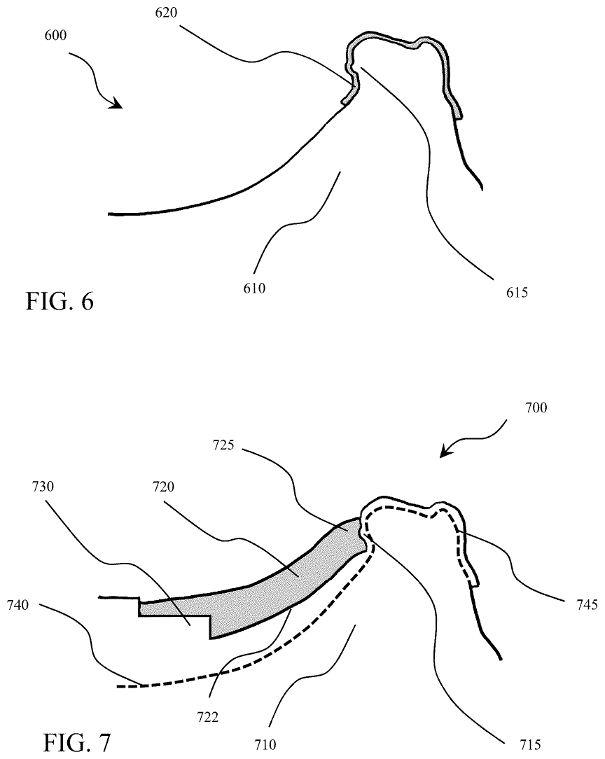

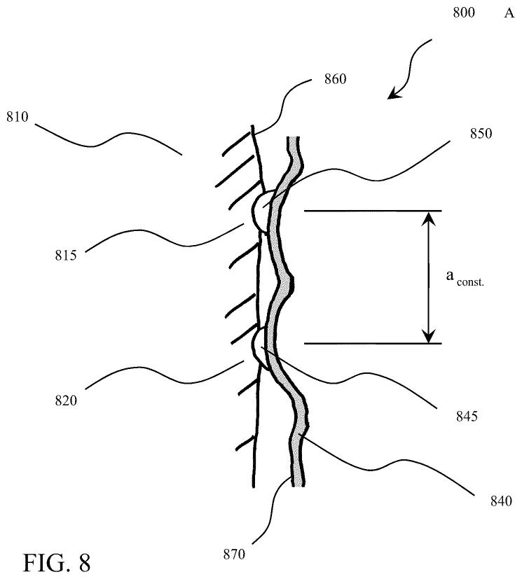

FIG. 7 shows a frontal cross-sectional view illustration of an exemplary embodiment of an augmented or otherwise modified 3D printed jaw model utilized as a mold in a process to manufacture an orthodontic custom-shaped expander in accordance with one or more embodiments of the present technology.

The cross-sectional illustrations in frontal view 700 in FIG. 7, where a remaining similar symmetric portion of the upper jaw or lower jaw, respectively, may be outside the range of the view of the cross-sectional illustration, shows in one or more exemplary embodiments of an augmented or otherwise modified 3D printed upper or lower jaw model 710 (in cross-sectional view) also referred to as a mold 710 (in cross-sectional view), that may be used as a tool for manufacturing an orthodontic custom-shaped expander 720, or one or more portions thereof that may be assembled in a subsequent manufacturing step. The expander 720 or an expander body 720 may be manufactured by primary shaping, where, for example, a thin liquid film of a separating agent is sprayed on and then the inner cavity of the mold is filed and/or build-up with biocompatible acrylic polymer/monomer dental resin mix, for example, in a so-called salt and pepper technique, to be hardened by pressure-polymerization in a temperature pressure pot or by UV-polymerization in a light chamber/oven. The mold may have an extension forming a receiving cavity 730 for a standard mass-produced expansion mechanic, as discussed above, that may be embedded in the acrylic material. Alternatively the cavity 730 may have a clip-in feature build in, to form a feature integral with the expander body 720 to position and hold the expansion mechanic. In this case the expansion mechanic may adhesively secured after its mounting in the expander body 720 or bodies 720. The mold 710 may have a protrusion 715 having an inverse spatial shape to form a female connector portion 725 integral with the expander body 720 (in cross-sectional view) comprised in the various exemplary embodiments of a form-lock interface between an aligner and a detachable custom-shaped orthodontic expander 720 according to various exemplary embodiments of the present technology. The mold 710 may have a custom-shaped surface forming a surface of expander body 722 that correlates to an anatomical shape or contour of the palate or of the lingual gingival mandibular anatomy of the patient undergoing orthodontic treatment as indicated in cross-sectional view as contour 740. The mold 710 may have a custom-shaped surface forming a surface of expander body 722 that correlates to an anatomical shape or contour of a tooth or a plurality of teeth of the patient the teeth as indicated in cross-sectional view as contour 745. The right and left expander bodies 720 as shown, for example in FIG. 1, may formed concurrently in one mold 710 or separately in two molds 710. After further processing, the custom-shaped orthodontic expander 720 (in cross-sectional view) may be a finished manufactured product prior to its insertion.

In yet one or more other exemplary embodiments of the present technology, a virtual model of the mold 710 may be derived from spatial image data of the patient and from a virtual model of an aligner to be operationally combined with the detachable custom-shaped orthodontic expander 720 (in cross-sectional view) according to various exemplary embodiments of the present technology. The mold 710 may be 3D printed responsive to the virtual model of the mold 710.

The patient and the orthodontic treatment, as each described in reference to FIG. 7 may represent the same or similar patient undergoing orthodontic treatment 1010 as shown in and described with respect to FIG. 10, or any of the FIGS. disclosed herein, and vice versa. The upper jaw and the lower jaw of the patient undergoing the orthodontic treatment, the palate, the lingual gingival mandibular anatomy, and the plurality of teeth, including a molar in cross-sectional view each as shown in and/or described in reference to FIG. 7 may represent the same or similar upper jaw, lower jaw, gingiva, palate, lingual gingival mandibular anatomy, and/or plurality of teeth, respectively, comprised in the dentition 1012 of the patient 1010 subjected to orthodontic treatment as shown in and/or described with respect to FIG. 10, or any of the FIGS. disclosed herein, and vice versa and/or may represent the same or similar gingiva 110, 140, 170, 210, 260, 320, 350, 380, 420, 515, 545, and 575, palate 112, 142, 172, 310, 340, 370, 410, 510, 540, and 570, lingual gingival mandibular anatomy 112, 142, 172, 310, 340, 370, 510, 540, and 570, or plurality of teeth 115, 145, 175, 220, 270, 305, 335, 365, and 405 (including the molar), respectively, each as shown in and/or described with respect to FIG. 1, FIG. 2, FIG. 3, FIG. 4, or FIG. 5 respectively, or any of the FIGS. disclosed herein, and vice versa. The form-lock interfaces described in reference to FIG. 7, may represent the same or similar form-lock interfaces 195, 595, and 615 as shown in and/or described with respect to FIG. 1, FIG. 3, FIG. 4, FIG. 5, or FIG. 6 respectively, or any of the FIGS. disclosed herein, and vice versa. The aligner as described in reference to FIG. 7 may represent the same or similar aligner comprised in the orthodontic appliance 1090 delivered as described with respect to FIG. 10, or any of the FIGS. disclosed herein, and vice versa and/or may represent the same or similar aligner 150, 180, 230, 280, 355, 385, 425, 427 (in cross-sectional view), 555, and 585 (each in cross-sectional view) of the plurality of aligners 150, 180, 230, 280, 355, 385, 425, and 427 (in cross-sectional view) 555, 585, and 620 (each in cross-sectional view) or each's details as shown in and described with respect to FIG. 1, FIG. 2, FIG. 3, FIG. 4, FIG. 5, or FIG. 6 respectively, or any of the FIGS. disclosed herein, and vice versa. The expander 720, and its details, each as shown in and/or described in reference to FIG. 7 may represent the same or similar expander comprised in the orthodontic appliance 1090 delivered as described with respect to FIG. 10, or any of the FIGS. disclosed herein, and vice versa and/or may represent the same or similar expander 190, 390, 430, and 590 and its details as shown in and described with respect to FIG. 1, FIG. 3, FIG. 4, or FIG. 5 respectively, or any of the FIGS. disclosed herein, and vice versa.

FIG. 8 shows a detailed cross-sectional occlusal view illustration of an exemplary embodiment of a form-lock interface between an orthodontic aligner and an orthodontic expander in accordance with one or more embodiments of the present technology.

The cross-sectional illustrations in occlusal view 800 A in FIG. 8 show in one or more exemplary embodiments of the present technology the detail A 198 of the form-lock interface 195 between the aligner 150, and 180, or the plurality of aligner 150, and 180 and the expander 190 as shown and/or described in FIG. 1. Unless the context requires otherwise, the expander or expander body 810 (in cross-sectional view), the aligner 840 (in cross-sectional view), the form-lock interface 800 and each's details 815, 820, 845 and 850, each as shown in and/or described in reference to FIG. 8 may represent the same or similar aligner 150, 180, 230, 280, 355, 385, 425, 427 (in cross-sectional view), 555, 585, and 620 (each in cross-sectional view) of the plurality of aligners 150, 180, 230, 280, 355, 385, 425, and 427 (in cross-sectional view) 555, 585, and 620 (each in cross-sectional view), expander 190, 390, 430, 590, and 720, form-lock interfaces 195, 595, and 615, or each's details as shown in and/or described with respect to FIG. 1, FIG. 2, FIG. 3, FIG. 4, FIG. 5, FIG. 6, or FIG. 7 respectively, or any of the FIGS. disclosed herein, and vice versa.

In order to provide concurrently an en masse movement of a plurality of right posterior teeth on one hand and a plurality of left posterior teeth of a dental jaw of the patient widening the dimensional transversal distance therebetween, the individual movement to align the posterior teeth within said plurality of right posterior teeth against each other, and the individual movement to align the posterior teeth within said plurality of left posterior teeth against each other, the geometry of the right and left form-lock interface 800, for example, can be fixed or constant, which means independent of the individual movements of posterior teeth adjacent the respective form-lock interface 800. There has not been recognition until now, that there is a substantial difference between engagers clinically recommended and used to enhance the grip of aligners with certain teeth, and the protrusions formed into an aligner, for example in the form of a male connector 845, and 850, each comprised in the form-lock interface 800. Engagers are adhesive build-ups on the respective crowns of certain teeth of the patient undergoing orthodontic aligner treatment, and correlating pockets within each tooth-receiving cavity of the aligner are providing an increased grip of the tooth-receiving pocket and the crown augmented by the build-up of the engager. As a series of aligners is configured to progressively reposition teeth against each other, the geometries of the tooth-receiving cavities are selected and arranged progressively in the direction of the repositioned teeth. The engagers are remaining on the crown of the teeth when the aligners are successively changed. Therefore, the pockets in the aligners adjacent each tooth-receiving cavity of the aligner, are configured to remain geometrically the same or similar with respect to the correlating tooth-receiving cavity of the series of aligners. In contrast, the protrusions formed into an aligner 840, for example in the form of a male connector 845, and 850, each comprised in the form-lock interface 800, may be configured to remain geometrically the same or similar with respect to configuration of the form-lock interface on the side of the expander 810 not necessarily with the adjacent tooth-receiving cavity of the aligners 840 or the plurality of aligners 840. In an exemplary embodiment of the present technology, each first right dimensional distance a_{const.} of a plurality of same or similar first right dimensional distances a_{const.} between a center of the right mesial male connector portion 845 and a center of the right distal male connector portion 850 of the correlating plurality of aligners 840 substantially matches a second right dimensional distance a_{const.} between a center of the right mesial female connector portion 820 and a center of the right distal female connector portion 815 of the expander 810. In another exemplary embodiment of the present technology, each first left dimensional distance a_{const.} of a plurality of same or similar first left dimensional distances a_{const} between a center of the left mesial male connector portion 845 and a center of the left distal male connector portion 850 of the correlating plurality of aligners 840 substantially matches a second left dimensional distance a_{const.} between a center of the left mesial female connector portion 820 and a center of the left distal female connector portion 815 of the expander 810. In yet another exemplary embodiment of the present technology, a surface 860 of the expander body 810 adjacent the interface configuration 815/820, may correlate to a surface 870 of the aligner 840 adjacent the interface configuration 845/850 (e.g., by having a matching shape, curve, or contour with the surface 870 of the aligner 840). In another exemplary embodiment of the present technology, the mesial female connector portion 820 and/or the distal female connector portion 815 may be designed and manufactured to have some play when compared to the mesial male connector portion 845 and/or the distal male connector portion 850. For example, a female connector portion may have an oval configuration of a vertical width of 2 mm and a mesial-distal length of 4 mm, while with male connector portion may have a spherical shape with a vertical width of 2 mm and a mesial-distal length of 2 mm.

See also, for example, FIG. 1, FIG. 2, FIG. 3, FIG. 4, and FIG. 5 for additional detailed aspects of embodiments that can be combined with the objects and/or features shown in reference to FIG. 8, in any combination. The patient and the orthodontic treatment, as each described in reference to FIG. 8 may represent the same or similar patient undergoing orthodontic treatment 1010 as shown in and described with respect to FIG. 10, or any of the FIGS. disclosed herein, and vice versa. The aligner 840 (in cross-sectional view), the expander 810 (in cross-sectional view) and each's details, each as shown in and/or described in reference to FIG. 8 may represent the same or similar aligner, or expander, respectively comprised in the orthodontic appliance 1090 delivered as described with respect to FIG. 10, or any of the FIGS. disclosed herein, and vice versa.

FIG. 9 shows several occlusal view illustrations of an exemplary embodiment of multiple method steps and various software functions and display options of arrangements of a plurality of teeth in the context of orthodontic space management in accordance with one or more embodiments of the present technology.

The four schematic illustrations in occlusal view are of the same or similar configurations of upper teeth 900, 920, 940, and 960 of a patient undergoing orthodontic treatment in FIG. 9, and show one or more exemplary embodiments of the same or similar plurality of teeth 905, 925, 945, and 965, including the same or similar upper lateral incisor 907, 927, 947, and 967, partially subjected to interproximal reduction (IPR), the same or similar maloccluded, original, and expanded and non-expanded target upper jaw archform 910, 930, 950, 952, and 970, and at least partially the same or similar indications of interproximal reduction (IPR) 935, and 975. The illustration 900 shows in an exemplary embodiment of a maloccluded configuration of upper teeth, a plurality of teeth 905, including an upper lateral incisor 907, and a maloccluded arch form 910. The illustration 920 shows in another exemplary embodiment of a theoretical configuration of upper teeth, a plurality of teeth 925, including the upper lateral incisor 927, the target arch form 930, and multiple indications of collisions or theoretical overlap 935 of multiple front teeth of the plurality of teeth 925, and 927. The illustration 940 shows in yet another exemplary embodiment of a target configuration of upper teeth, a plurality of teeth 945, including an upper lateral incisor 947, an indication of the maloccluded arch form 950, an expanded target arch form 952, and a direction of transversal expansion 955. Further, the illustration 960 shows in an exemplary embodiment of an alternative target configuration of upper teeth, a plurality of teeth 965, including an upper lateral incisor 967, a non-expanded target arch form 970, multiple indications of interproximal reduction (IPR) 975 of multiple front teeth of the plurality of teeth 965, and 967.

Further, the four schematic illustrations in occlusal view of the same or similar configurations of lower teeth 900, 920, 940, and 960 of a patient undergoing orthodontic treatment in FIG. 9 show in one or more exemplary embodiments of the same or similar plurality of teeth 905, 925, 945, and 965, including the same or similar lower lateral incisor 907, 927, 947, and 967, partially subjected to interproximal reduction (IPR), the same or similar maloccluded, original, and expanded and non-expanded target lower jaw archform 910, 930, 950, 952, and 970, and at least partially the same or similar indications of interproximal reduction (IPR) 935, and 975. The illustration 900 shows in an exemplary embodiment of a maloccluded configuration of lower teeth, a plurality of teeth 905, including a lower lateral incisor 907, and a maloccluded arch form 910. The illustration 920 shows in another exemplary embodiment a theoretical configuration of lower teeth, a plurality of teeth 925, including the lower lateral incisor 927, the target arch form 930, and multiple indications of collisions or theoretical overlap 935 of multiple front teeth of the plurality of teeth 925, and 927. The illustration 940 shows in yet another exemplary embodiment of a target configuration of lower teeth, a plurality of teeth 945, including a lower lateral incisor 947, an indication of the maloccluded arch form 950, an expanded target arch form 952, and a direction of transversal expansion 955. Further, the illustration 960 shows in an exemplary embodiment of an alternative target configuration of lower teeth, a plurality of teeth 965, including a lower lateral incisor 967, a non-expanded target arch form 970, multiple indications of interproximal reduction (IPR) 975 of multiple front teeth of the plurality of teeth 965, and 967.

The illustrations 940 and 960 show, for example, alternative outcomes of an orthodontic treatment of the patient depending on the decision of the treating dentist or orthodontist how to resolve the anterior crowding within the given maloccluded archform 910. The illustration 920, shows, for example, the tooth size discrepancies in the context of space management, as indicated by theoretical overlap 935. In other words the tooth material, e.g., the mesial-distal dimensions of each anterior of the plurality of teeth 905 (e.g., including the incisor 907) may not fit in an uncrowded manner the original archform 910, 930, 950, and 970 the patient presents. The treating dentist or dental specialist may prescribe interproximal reduction (IPR), shaving of the crowns of such teeth to thereby reducing the mesial-distal dimension of each anterior tooth so that the tooth material fits the original archform 910, 930, 950, and 970, as shown in illustration 960, for example on the lateral incisor 907 compared to the size of the same lateral incisor 967, having a reduced mesial-distal dimension. In yet another embodiment of the present technology, the dentist or dental specialist prescribes an aligner in combination with an expander according to the present technology to avoid interproximal reduction (IPR) as much as possible. The direction of expansion 955 in illustration 940 indicates a transversal force induced by such an expander to cause and support an orthodontic en masse movement of the plurality of right posterior teeth and the plurality of left posterior teeth of the plurality of teeth 945 widening the dimensional transversal distance therebetween. The expanded arch 952 (e.g., compared to the original archform 910, 930, 950, and 970) can accommodate the unchanged mesial-distal dimensions of the anterior teeth of the plurality of teeth 905, and 945, including the unchanged lateral incisor 907, and 947.

In one or more exemplary embodiments the four schematic illustrations 900, 920, 940, and 960 are showing schematic results of simulations of a plurality of teeth 900, 920, 940, and 960 of a dental jaw of a patient undergoing orthodontic treatment to assist in the prescription of space management to resolve the crowding in a patient undergoing orthodontic treatment. In one example, one jaw of a patient presents severe crowding and tooth removal is not an option. In this example, intercuspation of the upper and lower molar teeth so that distalization of posterior teeth (e.g., to gain space by moving posterior teeth distally or flaring out the anterior teeth) cannot be applied. Then, given the clinical constraints of the orthodontic case, interproximal reduction (IPR), (e.g., shaving off the mesial-distal dimension of the crowns of the crowded anterior teeth), or the transversal expansion of respective archform are the options the dentist or dental specialist may prescribe to resolve the crowding.

The patient and the orthodontic treatment, as each described in reference to FIG. 9 may represent the same or similar patient undergoing orthodontic treatment 1010 as shown in and described with respect to FIG. 10, or any of the FIGS. discussed herein, and vice versa. The aligner, the expander and each's details, each as described in reference to FIG. 9 may represent the same or similar aligner, or expander, respectively comprised in the orthodontic appliance 1090 delivered as described with respect to FIG. 10, or any of the FIGS. discussed herein, and vice versa, and may represent the same or similar aligner 150, 180, 230, 280, 355, 385, 425, 427 (in cross-sectional view), 555, 585, 620, and 840 (each in cross-sectional view) of the plurality of aligners 150, 180, 230, 280, 355, 385, 425, and 427 (in cross-sectional view) 555, 585, 620, and 840 (each in cross-sectional view), expander 190, 390, 430, 590, and 720, and 810 (in cross-sectional view), or each's details as shown in and/or described with respect to FIG. 1, FIG. 2, FIG. 3, FIG. 4, FIG. 5, FIG. 6, FIG. 7, or FIG. 8 respectively, or any of the FIGS. discussed herein, and vice versa.

FIG. 10 shows a block diagram illustrating an exemplary embodiment of an orthodontic treatment and related information technology (IT) and other systems configuration and method steps in accordance with one or more embodiments of the present technology.

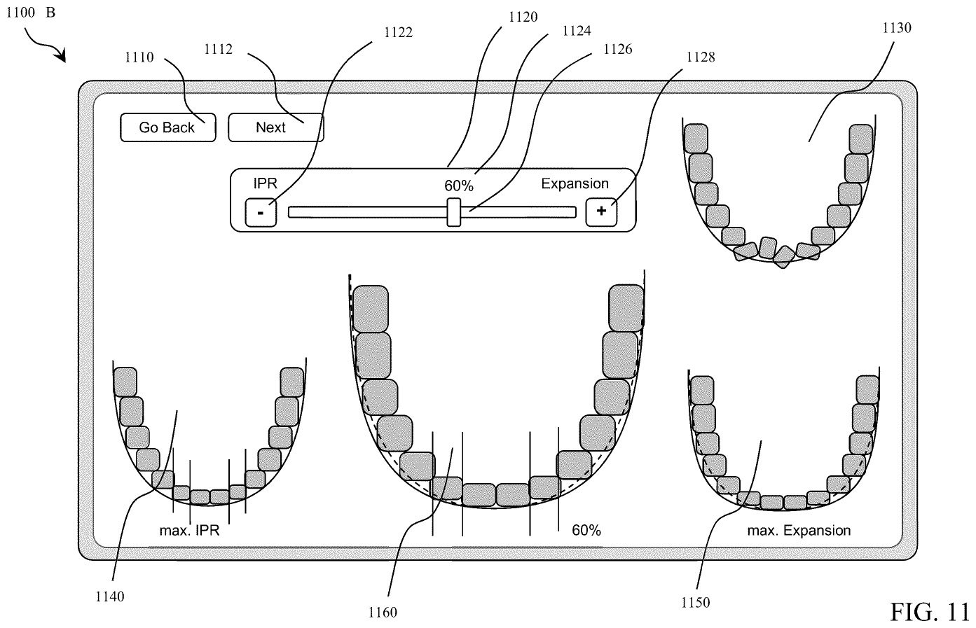

The system 1000 presented in FIG. 10 indicates in one or more exemplary embodiments a workflow, method steps, the flow of data, the acquisition of image data, the generation of a treatment plan, the CAD/CAM design and manufacturing and delivery of orthodontic appliances and the supporting information technology (IT) configuration assisting in the orthodontic treatment of a dentition 1012 of a patient 1010. For example, utilizing a handpiece of a 3D intraoral scanner 1020 connected to its control unit 1022, a spatial image of anatomical surfaces of the upper and/or lower jaw and its respective plurality of teeth (e.g., including a bite registration) of the dentition 1012 may be taken, the 3D scan data 1024, may be transferred 1032 through the internet 1040 to a cloud-based storage, including a database 1030, the scan may be subsequently made available 1059 to a personal computer (PC) for treatment planning 1050, comprising, for example, a computer monitor displaying, for example, various user interfaces, including the user interface for orthodontic space management, the detail B 1052, which is, for example, further shown and described with respect to FIG. 11. A treatment plan 1059 that may comprise a prescription by the treating dentist or dental specialist and a simulation of the target occlusion of the dentition 1012 of the patient 1010 may be transferred through the internet 1040 and may be made available 1069 to personal computer (PC) for CAD/CAM operations 1060, where the design of the orthodontic appliances may take place, and subsequently computer numerical control (CNC) data 1070, may be transferred to a manufacturing facility 1080, where, for example, equipment for primary, additive and/or subtractive manufacturing 1080 may be utilized to fabricate the prescribed, for example, the aligner(s) and/or expander(s) 1090 according to one or more exemplary embodiments of the present technology disclosed herein, responsive to the design data 1069, and 1070, which are, for example, delivered to the office of the treating dentist or dental specialist and may be handed to the patient 1010 for treatment of such patients dentition 1012. Each personal computer (PC) 1050, and 1060 may comprise a respective hardware and software configuration 1055, and 1065, comprising, for example, a memory 1056, and 1066, one or more processors 1057, and 1067, and a communications interface 1058, and 1068. The database 1030 may be stored on, and the memories 1056, and 1066 may comprise one or more non-transitory processor-readable media, as described in detail above. The computer data 1024, 1032, 1059, 1069, and 1070, and the computer data transferred within the hardware configurations 1055, and 1065 and within the manufacturing facility 1080 may be transferred and/or transmitted by any one or more physical, transferrable, and reproducible computer data signal as described in detail above utilizing any wired and wireless transmission device and technology, as described in detail above. The software configurations 1055, and 1065, may comprise one or more computer program products that may be received by the processor(s) 1057, and 1067, for example, by means of one or more non-transitory processor-readable media, or by one or more non-transitory computer data signal. The computer program products may be articles of manufacture, and may comprise firmware, operating systems, and/or applications. The computer program product may encode a computer program for executing on a computer system and/or one or more processors a computer process, comprising, for example, a plurality of functions. When implemented in software or firmware, various elements of the systems described herein can be code segments or instructions that perform the various tasks. The program or code segments can be stored in a processor-readable medium or transmitted by a computer data signal embodied in a carrier wave over a transmission medium or communication path.

In one or more exemplary embodiments, a computer program product 1055, and 1065 is configured to assist in an orthodontic treatment of a patient 1010, the computer program product 1055, and 1065 encoding a computer program for executing on a computer system 1050, and 1060 a computer process, the computer process comprising: receiving first numerical data 1024, 1032, 1059, and 1069 comprising a plurality of virtual custom-shaped first jaw crown geometries, a plurality of virtual custom-shaped opponent jaw crown geometries, and a virtual maloccluded spatial arrangement of the plurality of first jaw virtual custom-shaped crown geometries, and of the plurality of opponent jaw virtual custom-shaped crown geometries. Each virtual custom-shaped first jaw crown geometry of the plurality of virtual custom-shaped first jaw crown geometries can be descriptive of a correlating crown anatomy of a tooth of a plurality of first jaw teeth 1012 of the patient 1010. Additionally or alternatively, each virtual custom-shaped opponent jaw crown geometry of the plurality of virtual custom-shaped opponent jaw crown geometries is descriptive of a correlating crown anatomy of a tooth of a plurality of opponent jaw teeth 1012 of the patient 1010. Furthermore, the virtual maloccluded spatial arrangement can be descriptive of a maloccluded spatial arrangement of the plurality of first jaw teeth 1012 and of the plurality of opponent jaw teeth 1012 comprising a crowded spatial arrangement of the plurality of first jaw teeth 1012.

The computer process can further comprise receiving second numerical data descriptive of orthodontic space management criteria related to the first jaw 1012; wherein the orthodontic space management criteria comprising a first contribution amount of an anticipated interproximal reduction (IPR) resolving the crowded spatial arrangement of the plurality of first jaw teeth; reducing a plurality of virtual interproximal extensions of at least a portion of the plurality of first jaw virtual custom-shaped crown geometries responsive to the first contribution amount, if any, to thereby define a plurality of first jaw virtual custom-shaped updated crown geometries; simulating a virtual spatial arrangement of the plurality of first jaw virtual custom-shaped updated crown geometries of resolved crowding, having a transversally expanded archform; and/or displaying the virtual spatial arrangement of the plurality of first jaw virtual custom-shaped updated crown geometries of resolved crowding 1050, and 1060.

The computer system may comprise one or more processors 1057, and 1067. The processor(s) 1057, and 1067 may be operationally connected to a non-transitory processor-readable medium 1056, 1066, 1058, and 1068, 1059, and 1069 through or from which the processor(s) receives encoded computer program instructions, comprised in the computer program product. The non-transitory processor-readable medium 1056, 1066, 1058, and 1068, 1059, and 1069 may be a memory 1056, and 1066, for example a solid-state-drive (SSD) 1056, and 1066. The non-transitory processor-readable medium 1056, 1066, 1058, and 1068, 1059, and 1069 may be a computer data signal 1059, and 1069, transmitted, for example via a wireless local area network (WLAN) 1059, and 1069. The WLAN 1059, and 1069 may use a physical electromagnetic carrier signal to transfer the encoded program instructions, using a protocol that ensures the program instruction are reproducibly transferred.

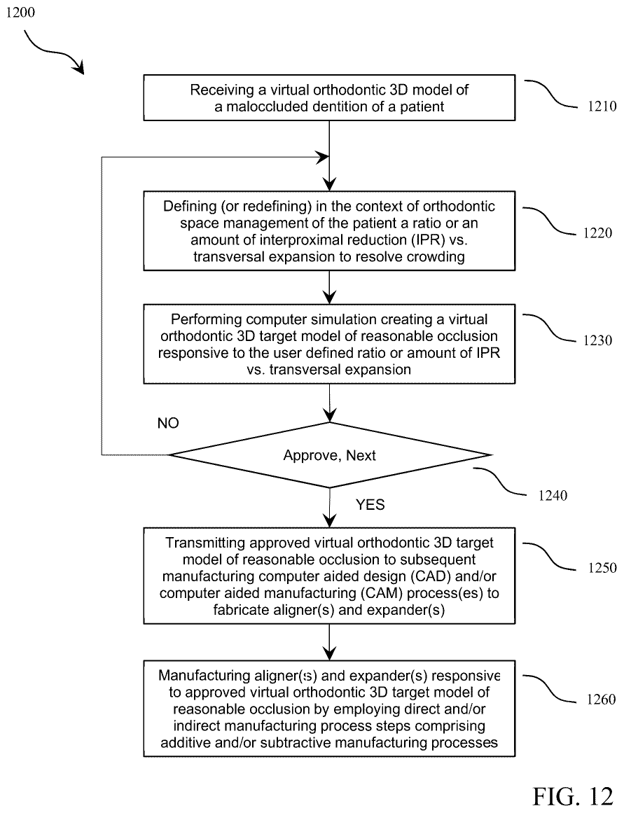

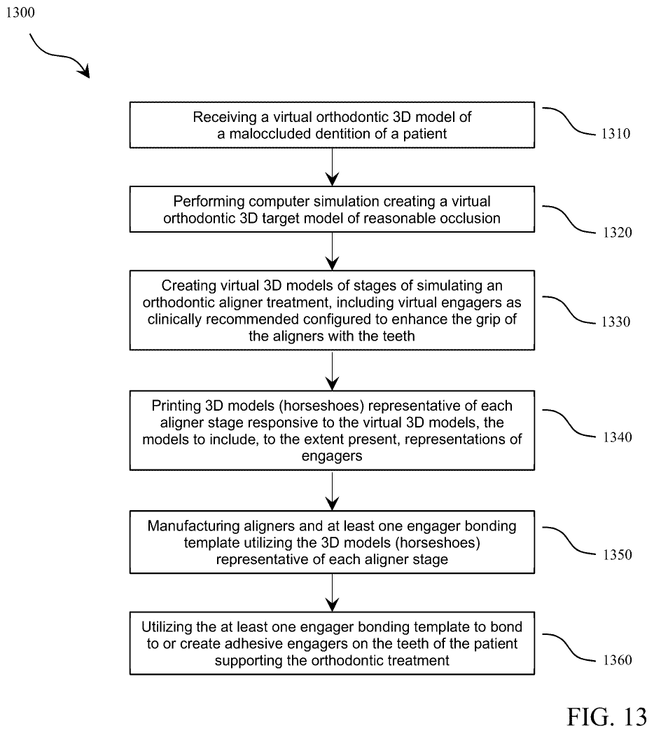

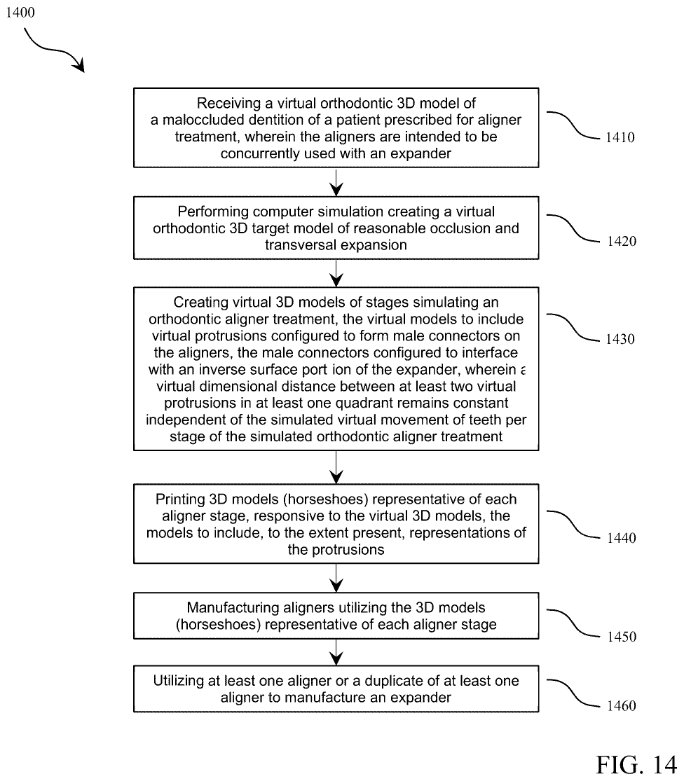

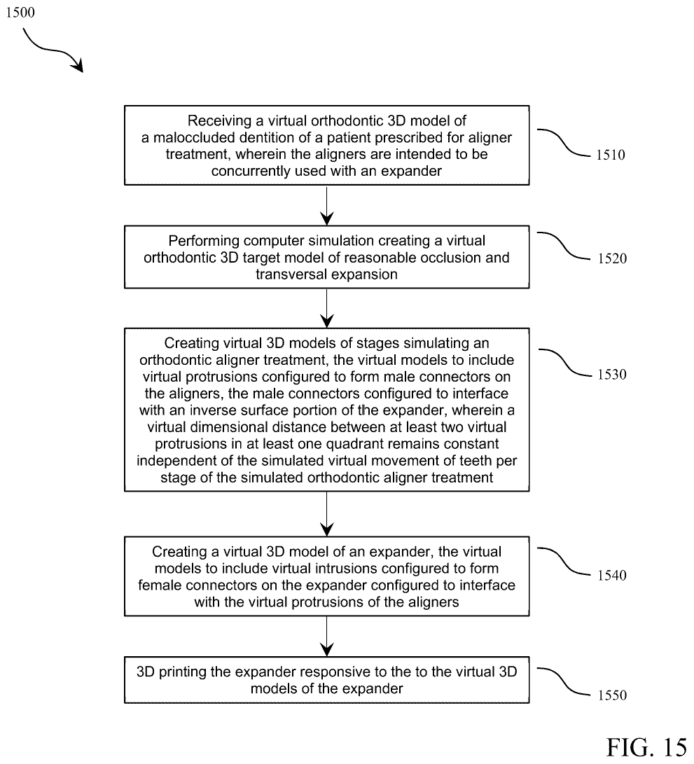

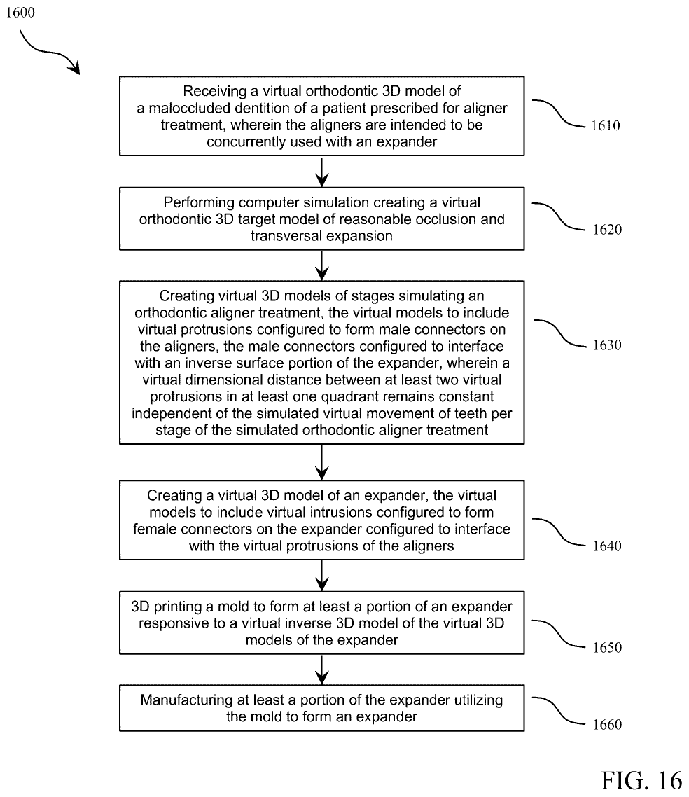

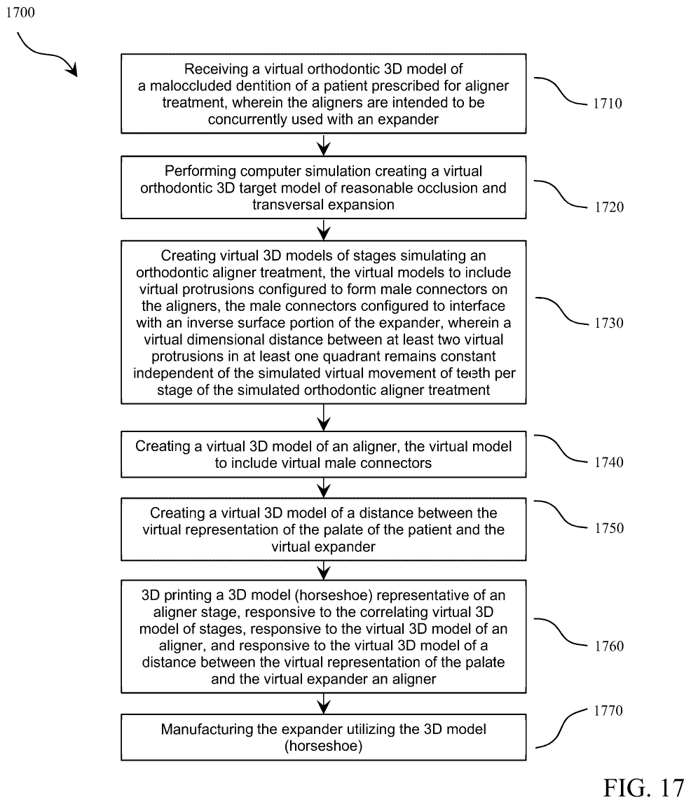

The aligner, the expander, as respectively comprised in the orthodontic appliance 1090 as described with respect to FIG. 10 may represent the same or similar aligner 150, 180, 230, 280, 355, 385, 425, 427 (in cross-sectional view), 555, 585, 620, and 840 (each in cross-sectional view) of the plurality of aligners 150, 180, 230, 280, 355, 385, 425, and 427 (in cross-sectional view) 555, 585, 620, and 840 (each in cross-sectional view), expander 190, 390, 430, 590, and 720, and 810 (in cross-sectional view), or each's details as shown in and/or described with respect to FIG. 1, FIG. 2, FIG. 3, FIG. 4, FIG. 5, FIG. 6, FIG. 7, or FIG. 8 respectively, or any of the FIGS. disclosed herein, as applicable, and vice versa. The treatment planning, space management, manufacturing technologies, virtual models, workflow, method steps, flow of data, image data, treatment plan, CAD/CAM design, manufacturing technologies, and each's details, each as described with respect to FIG. 10 may represent the same or similar the treatment planning, space management, manufacturing technologies, virtual models, workflow, method steps, flow of data, image data, treatment plan, CAD/CAM design, manufacturing technologies, or each's details respectively as shown in and/or described with respect to FIG. 9, FIG. 12, FIG. 13, FIG. 14, FIG. 15, FIG. 16, or FIG. 17 respectively, or any of the FIGS. disclosed herein, and vice versa.

FIG. 11 shows an exemplary embodiment of a display 1100 of a user interface (UI) generated by a treatment planning computer program product method for space management in accordance with one or more embodiments of the present technology.

The display 1100 shows in one or more exemplary embodiments a user interface for orthodontic space management of a patient undergoing orthodontic treatment, which provides details to illustrative element B 1052 as shown and/or described in FIG. 10. The discussion of space management, interproximal reduction (IPR) and transversal expansion as shown in and/or described with respect to FIG. 9, may apply in its entirety or in part using the display 1100.

In an embodiment the display 1100 is an interactive screen and is part of a treatment planning workflow focusing on space management in the event the patient presents crowding. The user, for example a dental technician or a dentist or dental specialist, may control the workflow by operating the first UI control element 1110 (e.g., Go Back button) going back to a previous stage in the workflow, for example, defining the maloccluded intercuspation in virtual upper and lower arch relationship responsive to a bite registration scan, or operating the second UI control element 1112 (e.g., Next button) to go forward to the next stage in the workflow, for example defining contact points of a reasonable occlusion. For example, an occlusal view of the maloccluded crowding that the patient presents is shown in the schematic display of maloccluded upper jaw tooth positions 1130. For example, an occlusal view of a simulated alignment of a plurality of teeth within the constraints of the existing archform the patient presents is shown in the schematic display of target tooth positions 1140 with virtual interproximal reduction (IPR) as necessary to resolve the crowding. For example, an occlusal view of a simulated alignment of a plurality of teeth without virtual interproximal reduction (IPR) based on a transversal widening of the archform of the patient is shown in the schematic display of target tooth positions 1150. The display 1100 is configured to efficiently assist the user to avoid shaving of the crowns of the crowded teeth, e.g., interproximal reduction (IPR) and/or to maintain and not undermine the integrity of the natural crowns of all teeth subjected to orthodontic treatment.

The system comprising an aligner and an expander, according to the various exemplary embodiments, may allow the dentist or dental specialist to prescribe a transversal expansion to avoid the discussed shavings of the crowns of the crowded teeth. The slider 1120, the + button 1122, the percentage display 1124, slider handle 1126, − button 1128 are user interface (UI) controls configured as a UI tool that allows the user to define a percentage of the contribution an interproximal reduction (IPR) will be presented (e.g., play) in the simulation of the plurality of teeth in the jaw resolving the crowding. The user may provide user input(s) to directly edit the percentage number in the percentage display 1124, may operate the + button 1122 or the − button 1128 to dial the percentage number up or down, and/or may operate and shift the slider handle 1126 to the right or the left to define the percentage number. The position of the slider handle 1126 and the percentage number in the percentage display 1124 may be coordinated so that, if the user operates one, the other shows a respectively adjusted position or, respectively, an updated correlating percentage number. When the percentage number is adjusted, for example to a number of 60% as shown in FIG. 11, a simulation of an alignment of the plurality of teeth is performed by the computer responsive to the percentage number, and the result is displayed and shown in an occlusal schematic view 1160 that is correlated to the percentage number. The display 1100 may be used to display an upper jaw crowding. The display 1100 may be used to display a lower jaw crowding. The schematic display of the occlusal view of the plurality of teeth may be replaced by an accurate virtual shape in occlusal view of the crowns of the plurality of teeth. A computer program product or a portion thereof may comprise the computer instructions to generate the interactive user interface on the display 1100, and to perform the simulations of the various outcomes as shown in the occlusal views 1130, 1140, 1150, and 1160.

The patient and the orthodontic treatment, as each described in reference to FIG. 11 may represent the same or similar patient undergoing orthodontic treatment 1010 as shown in and described with respect to FIG. 10, or any of the FIGS. disclosed herein, and vice versa. The aligner, the expander and each's details, each as described in reference to FIG. 11 may represent the same or similar aligner, or expander, respectively comprised in the orthodontic appliance 1090 delivered as described with respect to FIG. 10, or any of the FIGS. disclosed herein, and vice versa, and may represent the same or similar aligner 150, 180, 230, 280, 355, 385, 425, 427 (in cross-sectional view), 555, 585, 620, and 840 (each in cross-sectional view) of the plurality of aligners 150, 180, 230, 280, 355, 385, 425, and 427 (in cross-sectional view) 555, 585, 620, and 840 (each in cross-sectional view), expander 190, 390, 430, 590, and 720, and 810 (in cross-sectional view), or each's details as shown in and/or described with respect to FIG. 1, FIG. 2, FIG. 3, FIG. 4, FIG. 5, FIG. 6, FIG. 7, FIG. 8, or FIG. 9 respectively, or any of the FIGS. disclosed herein, and vice versa.

FIG. 12, FIG. 13, FIG. 14, FIG. 15, FIG. 16, and FIG. 17 show various illustrations of flow diagrams of methods for designing and manufacturing an orthodontic aligner, engager bonding template and/or an orthodontic expander in accordance with one or more embodiments of the present technology.

Flow diagram 1200 shows one or more other exemplary embodiments of a method including one or more steps for planning an orthodontic treatment, especially with respect to space management, designing and manufacturing aligner and expander configured to be concurrently used in an orthodontic treatment. The method depicted in diagram 1200 can comprise: method step 1210 of receiving a virtual orthodontic 3D model of a maloccluded dentition of a patient; method step 1220 of defining (e.g., or redefining) in the context of orthodontic space management of the patient a ratio or an amount of interproximal reduction (IPR) vs. transversal expansion to resolve crowding; method step 1230 of performing computer simulation creating a virtual orthodontic 3D target model of reasonable (e.g., adjusted, aligned, or realigned) occlusion responsive to the user defined ratio or amount of interproximal reduction (IPR) vs. transversal expansion; method step 1240 including an “Approve” or “Next” step indicating a user interaction accepting the simulation results of step 1240 and continuing to step 1250 or redefining the parameters in step 1220 and reiterate the simulation 1230; method step 1250 of transmitting approved virtual orthodontic 3D target model of reasonable occlusion to subsequent manufacturing computer aided design (CAD) and/or computer aided manufacturing (CAM) process(es) to fabricate aligner(s) and/or expander(s); and method step 1260 of manufacturing aligner(s) and/or expander(s) responsive to approved virtual orthodontic 3D target model of reasonable occlusion by employing direct and/or indirect manufacturing process steps comprising additive and/or subtractive manufacturing processes.

Flow diagram 1300 shows one or more exemplary embodiments of a method for planning an orthodontic treatment, designing and/or manufacturing aligners with engagers. The method depicted in diagram 1300 can comprise; method step 1310 of receiving a virtual orthodontic 3D model of a maloccluded dentition of a patient; method step 1320 of performing computer simulation creating a virtual orthodontic 3D target model of reasonable (e.g., adjusted, aligned, or realigned) occlusion; method step 1330 of creating virtual 3D models of stages of simulating an orthodontic aligner treatment, including virtual engagers configured to enhance the grip of the aligners with the teeth; method step 1340 of printing 3D models (e.g., horseshoes) representative of each aligner stage responsive to the virtual 3D models; the models to include, to the extent present, representations of engagers; method step 1350 of manufacturing aligners and at least one engager bonding template utilizing the 3D models (e.g., horseshoes) representative of each (e.g., or one or more) aligner stage; and method step 1360 of utilizing the at least one engager bonding template to bond to or create adhesive engagers on the teeth of the patient supporting the orthodontic treatment.

Flow diagram 1400 shows one or more exemplary embodiments of a method for planning an orthodontic treatment, designing and/or manufacturing aligner and expander configured to be concurrently used in an orthodontic treatment. The method depicted in flow diagram 1400 can comprise: method step 1410 of receiving a virtual orthodontic 3D model of a maloccluded dentition of a patient prescribed for aligner treatment; wherein the aligners can be concurrently used with an expander; method step 1420 of performing computer simulation creating a virtual orthodontic 3D target model of reasonable occlusion and transversal expansion; method step 1430 of creating virtual 3D models of stages simulating an orthodontic aligner treatment, the virtual models to include virtual protrusions configured to form male connector portions on the aligners, the male connector portions configured to interface with an inverse surface portion of the expander, wherein a virtual dimensional distance between at least two virtual protrusions in at least one quadrant remains constant independent of the simulated virtual movement of teeth per stage of the simulated orthodontic aligner treatment; method step 1440 of printing 3D models (e.g., horseshoes) representative of each (e.g., or one or more) aligner stage, responsive to the virtual 3D models, the models to include, to the extent present, representations of the protrusions; method step 1450 of manufacturing aligners utilizing the 3D models (e.g., horseshoes) representative of each (e.g., or one or more) aligner stage; and method step 1460 of utilizing at least one aligner or a duplicate aligner or a correlating thermoformable sheet of at least one aligner to manufacture an expander.

Flow diagram 1500 shows one or more exemplary of a method of planning an orthodontic treatment, designing aligner and/or expander configured to be concurrently used in an orthodontic treatment, and 3D printing the expander. The method depicted in diagram 1500 can comprise: method step 1510 of receiving a virtual orthodontic 3D model of a maloccluded dentition of a patient prescribed for aligner treatment, wherein the aligners can be concurrently used with an expander; method step 1520 of performing computer simulation creating a virtual orthodontic 3D target model of reasonable (e.g., adjusted, aligned, or realigned) occlusion and transversal expansion; method step 1530 of creating virtual 3D models of stages simulating an orthodontic aligner treatment, the virtual models to include virtual protrusions configured to form male connector portions on the aligners, the male connector portions configured to interface with an inverse surface portion of the expander, wherein a virtual dimensional distance between at least two virtual protrusions in at least one quadrant remains constant independent of the simulated virtual movement of teeth per stage of the simulated orthodontic aligner treatment; method step 1540 of creating a virtual 3D model of an expander, the virtual models to include virtual intrusions configured to form female connector portions on the expander configured to interface with the virtual protrusions of the aligners; and method step 1550 of 3D printing the expander responsive and/or corresponding to the virtual 3D models of the expander.

Flow diagram 1600 shows one or more exemplary embodiments of a method of planning an orthodontic treatment, designing aligner and/or expander configured to be concurrently used in an orthodontic treatment, and manufacturing indirectly the expander utilizing a 3D printed mold. The method depicted in diagram 1600 can comprise: method step 1610 of receiving a virtual orthodontic 3D model of a maloccluded dentition of a patient prescribed for aligner treatment, wherein the aligners can be concurrently used with an expander; method step 1620 of performing computer simulation creating a virtual orthodontic 3D target model of reasonable (e.g., adjusted, aligned, or realigned) occlusion and transversal expansion; method step 1630 of creating virtual 3D models of stages simulating an orthodontic aligner treatment, the virtual models to include virtual protrusions configured to form male connector portions on the aligners, the male connector portions configured to interface with an inverse surface portion of the expander, wherein a virtual dimensional distance between at least two virtual protrusions in at least one quadrant remains constant independent of the simulated virtual movement of teeth per stage of the simulated orthodontic aligner treatment; method step 1640 of creating a virtual 3D model of an expander, the virtual models to include virtual intrusions configured to form female connector portions on the expander configured to interface with the virtual protrusions of the aligners; method step 1650 of 3D printing a mold to form at least a portion of an expander responsive to a virtual inverse 3D model of the virtual 3D models of the expander; and method step 1660 of manufacturing at least a portion of the expander utilizing the mold to form an expander.

Flow diagram 1700 shows one or more exemplary embodiments of a method for planning an orthodontic treatment, designing aligner and/or expander configured to be concurrently used in an orthodontic treatment, and 3D printing a 3D model (e.g., horseshoe) facilitating the manufacturing of an expander. The method depicted in flow diagram 1700 can comprise: method step 1710 of receiving a virtual orthodontic 3D model of a maloccluded dentition of a patient prescribed for aligner treatment, wherein the aligners can be concurrently used with an expander; method step 1720 of performing computer simulation creating a virtual orthodontic 3D target model of reasonable (e.g., adjusted, aligned, or realigned) occlusion and transversal expansion; method step 1730 of creating virtual 3D models of stages simulating an orthodontic aligner treatment, the virtual models to include virtual protrusions configured to form male connector portions on the aligners; the male connector portions configured to interface with an inverse surface portion of the expander, wherein a virtual dimensional distance between at least two virtual protrusions in at least one quadrant remains constant independent of the simulated virtual movement of teeth per stage of the simulated orthodontic aligner treatment; method step 1740 of creating a virtual 3D model of an aligner, the virtual model to include virtual male connector portions; method step 1750 of creating a virtual 3D model of a distance between the virtual representation of the palate of the patient and the virtual expander; and method step 1760 of manufacturing the expander utilizing the 3D model (e.g., horseshoe).

It is to be understood that the specific order or hierarchy of operations in the methods 600 depicted in FIGS. 12-17 and throughout this disclosure are instances of example approaches and can be rearranged while remaining within the disclosed subject matter. For instance, any of the operations depicted in FIGS. 12-17 and throughout this disclosure can be omitted, repeated, performed in parallel, performed in a different order, and/or combined with any other of the operations depicted in FIGS. 12-17 and throughout this disclosure.

The patient and the orthodontic treatment, as each described in reference to FIG. 12, FIG. 13, FIG. 14, FIG. 15, FIG. 16, or FIG. 17 respectively may represent the same or similar patient undergoing orthodontic treatment 1010 as shown in and described with respect to FIG. 10, or any of the FIGS. disclosed herein, and vice versa. The aligner, the expander, the engager bonding template, and each's details, and all virtual elements, each as described in reference to FIG. 12, FIG. 13, FIG. 14, FIG. 15, FIG. 16, or FIG. 17 may represent the same or similar aligner, or expander, respectively comprised in the orthodontic appliance 1090, delivered as described with respect to FIG. 10, or any of the FIGS. disclosed herein, and vice versa, and may represent the same or similar aligner 150, 180, 230, 280, 355, 385, 425, 427 (in cross-sectional view), 555, 585, 620, and 840 (each in cross-sectional view) of the plurality of aligners 150, 180, 230, 280, 355, 385, 425, and 427 (in cross-sectional view) 555, 585, 620, and 840 (each in cross-sectional view), expander 190, 390, 430, 590, and 720, and 810 (in cross-sectional view), engager bonding template, and each's details, and all virtual elements as shown in and/or described with respect to FIG. 1, FIG. 2, FIG. 3, FIG. 4, FIG. 5, FIG. 6, FIG. 7, FIG. 8, FIG. 9, FIG. 10, or FIG. 11 respectively, or any of the FIGS. disclosed herein, and vice versa.

In yet another exemplary embodiment, a method, a process, and/or a computer program function described herein, for example, as shown in and/or described with respect to FIG. 2, FIG. 6, FIG. 7, FIG. 9, FIG. 10, FIG. 11, FIG. 12, FIG. 13, FIG. 14, FIG. 15, FIG. 16, and/or FIG. 17, respectively, is configured to carry out one or more method or process steps or functions listed in the preceding paragraphs, in no or in any order.

In yet another exemplary embodiment, an implementation, and/or a system described herein, for example, as shown in FIG. 1, FIG. 2, FIG. 3, FIG. 4, FIG. 5, FIG. 6, FIG. 7, FIG. 8, FIG. 9, FIG. 10, and/or FIG. 11, respectively, or as described above, may comprise one or more of the features listed in the preceding paragraphs, in any combination. In various implementations, described process(es) may be implemented by various described system(s), such as systems or subsystems 100, 130, 160, 200, 250, 300, 330, 360, 400, 500, 530, 560, 600, 700, 800, 900, 920, 940, 960, 1000, 1100. In addition, various described operation(s) may be added, deleted, and/or modified in implementations of the described process(es) and/or system(s). In some implementations, a described process or operations thereof may be performed in combination with other described process(es) or operations thereof.

Whenever the context requires, all words used in the singular number shall be deemed to include the plural and vice versa. Words which import one gender shall be applied to any gender wherever appropriate. Whenever the context requires, all options that are listed with the word “and” shall be deemed to include the world “or” and vice versa, and any combination thereof. If applicable, the words “vice versa” shall be deemed to include the term “the other way around.” Unless the context herein otherwise requires, the words “include”, “for example”, “by way of example”, “exempli gratia” or “e.g.” and derivative or similar terms shall be deemed in each case to be followed by the words “without limitation.”

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed:

1. A system to assist in an orthodontic treatment of a patient, the system comprising:
a plurality of orthodontic aligners configured to progressively reposition a plurality of teeth of a dental jaw of the patient during the orthodontic treatment when successively and operationally positioned; and
an orthodontic expander couplable to the plurality of orthodontic aligners and shaped to apply a transversal force that widens a dimensional distance between a plurality of right posterior teeth of the plurality of teeth and a plurality of left posterior teeth of the plurality of teeth of the dental jaw when positioned between the plurality of right posterior teeth and the plurality of left posterior teeth;
wherein the orthodontic expander successively forms a plurality of right form-lock interfaces and a plurality of left form-lock interfaces with the successively positioned plurality of orthodontic aligners during the orthodontic treatment so that the plurality of orthodontic aligners positions the orthodontic expander and act as an intermediary to translate the transversal force onto the plurality of right posterior teeth and onto the plurality of left posterior teeth.

2. The system as recited in claim 1, wherein the plurality of orthodontic aligners have different right teeth-receiving cavity geometries adjacent the plurality of right posterior teeth, the right teeth-receiving cavity geometries selected to progressively reposition the plurality of right posterior teeth against each other during the orthodontic treatment when the plurality of orthodontic aligners are successively combined with the orthodontic expander; and
wherein the plurality of right form-lock interfaces have a same position relative to a plurality of right locking interfaces of the plurality of orthodontic aligners despite being positioned adjacent a lingual right posterior aligner shape variability of the different right teeth-receiving cavity geometries.

3. The system as recited in claim 1, wherein the plurality of orthodontic aligners have different left teeth-receiving cavity geometries adjacent the plurality of left posterior teeth, the left teeth-receiving cavity geometries selected to progressively reposition the plurality of left posterior teeth against each other during the orthodontic treatment when the plurality of orthodontic aligners are successively combined with the orthodontic expander; and
wherein the plurality of left form-lock interfaces have a same position relative to a plurality of left locking interfaces of the plurality of orthodontic aligners despite being positioned adjacent a lingual left posterior aligner shape variability of the different left teeth-receiving cavity geometries.

4. The system as recited in claim 1, wherein
the orthodontic expander includes an aligner-facing right interface portion;
the plurality of orthodontic aligners include a plurality of lingual right posterior aligner interface portions that, with the aligner facing right interface portion of the orthodontic expander, forms the plurality of right form-lock interfaces;
the aligner-facing right interface portion includes an integral right mesial female connector portion and an integral right distal female connector portion; and
the plurality of lingual right posterior aligner interface portions include:
an integral right mesial male connector portion correlating to the right mesial female connector portion; and
an integral right distal male connector portion correlating to the right distal female connector portion.

5. The system as recited in claim 1, wherein:
the orthodontic expander includes an aligner-facing left interface portion;
the plurality of orthodontic aligners include a plurality of lingual left posterior aligner interface portions that, with the aligner-facing left interface portion, forms the plurality of left form-lock interfaces;
the aligner-facing left interface portion includes an integral left mesial female connector portion and an integral left distal female connector portion; and
the plurality of lingual left posterior aligner interface portions include:
an integral left mesial male connector portion correlating to the left mesial female connector portion; and
an integral left distal male connector portion correlating to the left distal female connector portion.

6. The system as recited in claim 4, wherein a first right dimensional distance between a center of the right mesial male connector portion and a center of the right distal male connector portion is consistent and matches a second right dimensional distance between a center of the right mesial female connector portion and a center of the right distal female connector portion of the orthodontic expander while successively and operationally positioning the plurality of orthodontic aligners.

7. The system as recited in claim 5, wherein a first left dimensional distance between a center of the left mesial male connector portion and a center of the left distal male connector portion is consistent and matches a second left dimensional distance between a center of the left mesial female connector portion and a center of the left distal female connector portion of the orthodontic expander while successively and operationally positioning the plurality of orthodontic aligners.

8. The system as recited in claim 1, wherein the dental jaw is an upper jaw, the plurality of orthodontic aligners are shaped as upper jaw aligners, and the orthodontic expander is shaped as an upper jaw expander comprising at least one extended portion having a bite plane surface configured to intrude a plurality of lower front teeth when operationally positioned.

9. The system as recited in claim 1, wherein the dental jaw is a lower jaw, the plurality of orthodontic aligners are shaped as lower jaw aligners, and the orthodontic expander is shaped as a lower jaw expander.

10. The system as recited in claim 1, further comprising an adjustable screw at the orthodontic expander to adjust the transversal force.

11. A method of manufacturing a orthodontic expander to be concurrently used with a plurality of orthodontic aligners to assist in an orthodontic treatment of a patient, the method comprising:
determining an anatomical surface of a dental anatomy of a dental jaw of the patient;
determining a widening dimensional distance between a plurality of right posterior teeth and a plurality of left posterior teeth of a plurality of teeth of a dental jaw of the patient to be formed with a transversal force applied by the orthodontic expander when the orthodontic expander is operationally positioned;
forming a first surface of spatial extension of the orthodontic expander correlating to at least one spatially shaped surface of the anatomical surface; and
forming a second surface of spatial extension of the orthodontic expander correlating to a virtual inverse surface of a corresponding at least one lingual posterior surface of spatial extension of at least one orthodontic aligner of the plurality of orthodontic aligners.

12. The method as recited in claim 11, wherein:
the dental jaw is an upper jaw of the patient;
the dental anatomy comprises a palate of the patient; and
the orthodontic expander is shaped as an upper jaw expander, wherein the at least one surface of spatial extension faces the palate.

13. The method as recited in claim 12, wherein at least one custom-shaped surface of spatial extension of the orthodontic expander is a first custom-shaped surface of spatial extension of the orthodontic expander, and the method further comprises:
forming a second custom-shaped surface of spatial extension of the orthodontic expander configured to intrude a plurality of lower front teeth when operationally positioned.

14. The method as recited in claim 11, wherein:
the dental jaw is a lower jaw of the patient;
the dental anatomy is a lingual gingival mandibular anatomy of the patient;
the orthodontic expander is shaped as a lower jaw expander; and
the at least one surface of spatial extension faces the lingual gingival mandibular anatomy.

15. The method as recited in claim 11, wherein:
the at least one surface of spatial extension of the orthodontic expander includes a right spatially shaped surface and a left spatially shaped surface;
the at least one lingual posterior surface includes a right lingual posterior surface and a left lingual posterior surface;
the right spatially shaped surface and the right lingual posterior surface form a right form-lock interface;
the left spatially shaped surface and the left lingual posterior surface form a left form-lock interface; and
the right form-lock interface and the left form-lock interface position and hold the orthodontic expander when operationally combined.

16. The method as recited in claim 11, wherein forming the at least one surface of spatial extension of the orthodontic expander employs at least one of:
a 3D printer configured to print at least a portion of the orthodontic expander from biocompatible material;
a 5-axis computer numerical controlled (CNC) milling machine configured to machine at least a portion of the orthodontic expander from a biocompatible material blank;
equipment using CNC based subtractive forming technologies;
equipment using CNC based additive forming technologies; and
equipment using CNC based primary shaping or forming.

17. The method as recited in claim 11, further comprising:
receiving a first physical model having a custom-shaped surface of spatial extension representative of the anatomical surface of the dental anatomy of the dental jaw of the patient;
receiving a second physical model having at least one spatially shaped surface of spatial extension representative of the at least one lingual posterior surface of spatial extension of the orthodontic aligner; and
wherein forming the first surface of spatial extension of the orthodontic expander uses the first physical model as a first tool, and forming the second surface of spatial extension uses the second physical model as a second tool.

18. The method as recited in claim 17, wherein the first physical model includes at least one of: a stone model, a gypsum model, a 3D printed model, or a wax-up model.

19. The method as recited in claim 17, wherein the second physical model includes at least one of: the at least one orthodontic aligner, a duplicate of the at least one orthodontic aligner, and a thermoformable sheet replicating at least a portion of the at least one orthodontic aligner.

20. The method as recited in claim 11, further comprising:
receiving a physical model having a custom-shaped surface of spatial extension correlating to the anatomical surface of the dental anatomy of the dental jaw of the patient; and
wherein forming the at least one surface of spatial extension of the orthodontic expander uses the physical model as a mold.

21. The method as recited in claim 11, the method further comprising:
receiving spatial imaging data descriptive of the dental anatomy of the dental jaw of the patient;
receiving first numerical data descriptive of at least one lingual posterior surface of the orthodontic aligner; and
deriving a virtual custom-shaped model descriptive of at least the first surface of spatial extension and the second surface of the spatial extension from the spatial imaging data and the first numerical data;
wherein forming the at first surface of spatial extension and the second surface of spatial extension uses computer numerical controlled (CNC) based equipment operating responsive to the virtual custom-shaped model.

22. A method of manufacturing a plurality of orthodontic aligners configured to be concurrently used with an orthodontic expander to assist in an orthodontic treatment of a patient, the method comprising:
receiving a first virtual surface correlating to a first set of virtual crown geometries of a plurality of virtually repositioned teeth correlating to a plurality of teeth to thereby define a plurality of virtual teeth-receiving cavity geometries configured to reposition the plurality of teeth;
receiving a second virtual surface correlating to a right lingual posterior interface and a left lingual posterior interface of the orthodontic aligner; wherein:
a right lingual posterior interface of an orthodontic aligner of the plurality of orthodontic aligners is configured to form a right form-lock interface between the orthodontic expander and the orthodontic aligner;
a left lingual posterior interface of the orthodontic aligner is configured to form a left form-lock interface between the orthodontic expander and the orthodontic aligner; and
the orthodontic aligner uses the right form-lock interface and the left form-lock interface to position the orthodontic expander and act as an intermediary to translate a transversal force onto a plurality of right posterior teeth and a plurality of left posterior teeth, thus widening a dimensional distance between the plurality of right posterior teeth and the plurality of left posterior teeth of a dental jaw of the patient during the orthodontic treatment; and
3D printing a part at least partially responsive to the first virtual surface and the second virtual surface so that a first custom-shaped surface of spatial extension of the part correlates to the first virtual surface and a second surface of substantial spatial extension of the part correlates to the second virtual surface.

23. The method as recited in claim 22, wherein the part is the orthodontic aligner of the plurality of orthodontic aligners.

24. The method as recited in claim 22, wherein the part is a custom-shaped horseshoe, and the method further comprises thermoforming the orthodontic aligner using the custom-shaped horseshoe as a tool.

25. A computer program product to assist in an orthodontic treatment of a patient, the computer program product encoding a computer program for executing on a computer system a computer process, the computer process comprising:
receiving first numerical data including:
a plurality of virtual jaw crown geometries;
a plurality of virtual opponent jaw crown geometries; and
a virtual maloccluded spatial arrangement of the plurality of virtual jaw crown geometries, and of the plurality of virtual opponent jaw crown geometries;
wherein:
the plurality of virtual jaw crown geometries represent a plurality of correlating crown anatomies of a plurality of jaw teeth of the patient;
the plurality of virtual opponent jaw crown geometries represent a plurality of correlating crown anatomies of a plurality of opponent jaw teeth of the patient; and
the virtual maloccluded spatial arrangement represents a maloccluded spatial arrangement of the plurality of jaw teeth and of the plurality of opponent jaw teeth including a crowded spatial arrangement of the plurality of jaw teeth;
receiving second numerical data descriptive of at least one orthodontic space management criteria related to the plurality of j aw teeth, wherein the at least one orthodontic space management criteria includes a first prescription of an anticipated interproximal reduction (IPR) resolving the crowded spatial arrangement of the plurality of j aw teeth;
reducing a plurality of virtual interproximal extensions of at least a portion of the plurality of virtual jaw crown geometries responsive to the first prescription to define a plurality of virtual updated crown geometries;
simulating a virtual spatial arrangement of the plurality of virtual updated crown geometries having a transversally expanded virtual archform to resolve the crowded spatial arrangement; and
displaying the virtual spatial arrangement of the plurality of virtual updated crown geometries having the transversally expanded virtual archform.

26. A computer system executing the computer program product as recited in claim 25, wherein the computer system comprises one or more processors that receive the computer program from a non-transitory processor-readable memory, and displaying the virtual spatial arrangement of the plurality of virtual updated crown geometries includes presenting the virtual spatial arrangement at a user interface of a clinic device.

27. A computer implemented method to assist in an orthodontic treatment of a patient presenting anterior crowding in a dental jaw, the computer implemented method comprising:
receiving a plurality of virtual crown geometries descriptive of a plurality of teeth of the dental jaw of the patient;
providing a user interface in a first area of a computer screen to receive a prescription of an anticipated interproximal reduction of a tooth or a plurality of teeth;
simulating an orthodontic treatment of the patient virtually resolving the anterior crowding responsive to a user input at the user interface, to thereby define a prescription; and
displaying a virtual orthodontic model, resulting from simulating the orthodontic treatment, on a second area of the computer screen at least in an occlusal view of the virtual orthodontic model;
wherein simulating the orthodontic treatment includes:
modifying the plurality of virtual crown geometries responsive to the prescription;
applying a virtual transversal expansion to widen a distance between right and left posterior crowns of the plurality of virtual crown geometries; and
aligning anterior crowns of the plurality of virtual crown geometries so that the anterior crowding is resolved.

28. The method as recited in claim 27, wherein the prescription omits anticipated interproximal reduction of a tooth or a plurality of teeth, and the anterior crowding is resolved fully by the virtual transversal expansion to widen a distance between right and left posterior crowns.
